(19) United States
(12) Patent Application Publication
(10) Pub. No.: US 2023/0217557 A1
(43) Pub. Date: Jul. 6, 2023

(54) COOKING APPLIANCE

(71) Applicant: LG ELECTRONICS INC., Seoul (KR)

(72) Inventors: Taehong YEO, Seoul (KR); Dongkwan Yu, Seoul (KR); Dong Hun KIM, Seoul (KR)

(21) Appl. No.: 18/080,505

(22) Filed: Dec. 13, 2022

(30) Foreign Application Priority Data
Jan. 3, 2022 (KR) 10-2022-0000547
Mar. 25, 2022 (KR) 10-2022-0037637
Mar. 25, 2022 (KR) 10-2022-0037685
Jun. 2, 2022 (KR) 10-2022-0067821
Jun. 2, 2022 (KR) 10-2022-0067822

(51) Int. Cl. H05B 6/64; E05B 13/00; E05C 3/16

(52) U.S. Cl. CPC H05B 6/6414; E05B 13/002; E05C 3/162

(57) ABSTRACT

A cooking appliance includes a main body having a cooking chamber therein and open at a front side thereof, a door provided to the front side of the main body to open or close the cooking chamber, a door button capable of being pressed by user manipulation and to move to a pressed position to allow the door to be opened, and a locking mechanism selectively restricting movement of the door button. The locking mechanism includes a locking rod allowing change of a posture thereof to a locking posture restricting movement of the door button to the pressed position and an unlocking posture allowing movement of the door button to the pressed position; and a manipulation button capable of being pressed by user manipulation and changing the posture of the locking rod from the locking posture to the unlocking posture when pressed by user manipulation.

### CROSS-REFERENCE TO RELATED APPLICATION

This application claims priority to and the benefit of Korean Patent Application Nos. 10-2022-0000547, 10-2022-0037637, 10-2022-0037685, 10-2022-0067821, 10-2022-0067822, filed on Jan. 3, 2022, Mar. 25, 2022, Mar. 25, 2022, Jun. 2, 2022, and Jun. 2, 2022, respectively, the disclosure of which are incorporated herein by reference in its entirety.

### BACKGROUND

### Technical Field

Embodiments of the present disclosure relate to a cooking appliance, more particularly to a cooking appliance having a door adapted to open or close a cooking chamber.

### Background

A cooking appliance is a household appliance used for cooking food and is installed in a kitchen space to cook food according to a user's intention. The cooking appliance may be classified in various ways according to the kind of heat source, cooking type, or the kind of fuel.

Cooking appliances may be classified as an open type and a closed type according to a cooking type, that is, according to the shape of a cooking space in which food is placed at the cooking appliance. The closed type cooking appliances include ovens, microwave ovens, and the like, and the open type cooking appliances include cook-tops, hobs, and the like.

The closed type cooking appliances are cooking appliances that shield a space for receiving food and cook the food by heating the shielded space. A closed type cooking appliance is provided with a chamber, that is, a cooking chamber, which corresponds to a space for receiving food and shielded upon cooking, inside a main body of the cooking appliance. Such a cooking chamber defines the space in which food is substantially cooked. A heat source is disposed inside or outside the cooking chamber to heat the cooking chamber.

As one of the closed type cooking appliances, a microwave oven is a cooking appliance that generates microwaves using electricity such that the microwaves penetrate a cooking object received in the cooking chamber to heat the cooking object through molecular vibration caused by the microwaves.

The microwave oven is a kitchen appliance that heats the interior of food and the exterior thereof at the same time by irradiating the food with high frequency from a magnetron. The microwave oven is widely used due to its advantages such as high thermal efficiency to achieve great reduction in cooking time, reduction in loss of nutritional values during cooking, thawing, and warming of the food, direct cooking of food stored in a food container, and the like.

Such a microwave oven is typically provided with a door adapted to open or close the cooking chamber formed inside the main body thereof. The door for the microwave oven may be classified into a left-right opening/closing door, an up-down opening/closing door, a sliding door, and the like, and thus classified according to the opening/closing type. The left-right opening/closing door is most generally used.

In addition, a latch may be disposed between the main body and the door to selectively secure the door, which opens or closes the cooking chamber. The latch may function as a hook to maintain a closed state of the door while detecting the closed state of the door so to prevent cooking from proceeding when the door is in an open state.

Typically, the latch does not secure the door such that the door cannot be completely opened. That is, when a predetermined amount or more of force is applied to the door in the closed state, the secured state of the door by the latch is released without any other manipulation, whereby the door may rotate or slide to open the cooking chamber.

With the opening/closing structure of the door described above, since the door may be easily opened when a user pulls on the door, unintentional opening of the cooking chamber may often occur during operation of the microwave oven due to a user's mistake or a child's prank.

When the cooking chamber is unintentionally opened during operation of the microwave oven, there is a risk that the user can be injured, such as burns, due to heat inside the cooking chamber during cooking.

Moreover, if children frequently open and close the door even in the case where cooking is not performed, the latch may wear quickly, causing unstable opening/closing operation of the door due to the worn latch.

### SUMMARY

Embodiments of the present disclosure provide a cooking appliance that improves reliability in securing of a door for preventing unintentional opening of a cooking chamber.

Embodiments of the present disclosure provide a cooking appliance that allows a door to be easily and conveniently locked and unlocked.

Embodiments of the present disclosure provide a cooking appliance that allows a dual door-securing function for stably securing the door to be selected by a user, as needed.

Embodiments of the present disclosure provide a cooking appliance that has a reduced number of components and improves manipulation accuracy.

In order to achieve the above and other aspects of the present disclosure, a cooking appliance according to one embodiment of the present disclosure includes: a locking mechanism selectively preventing backward movement of a door button adapted to open a door, wherein the locking mechanism includes a locking rod allowing change of a posture thereof and a manipulation button capable of being pressed by user manipulation, the manipulation button changing the posture of the locking rod to a posture restricting the backward movement of the door button and a posture allowing the backward movement of the door button.

With this structure, the cooking appliance allows a user to select use of a dual door-securing function for stably securing the door, as needed.

In order to achieve the above and other aspects of the present disclosure, a cooking appliance according to one embodiment of the present disclosure includes: a locking mechanism selectively preventing backward movement of a door button adapted to open a door, wherein the locking mechanism includes a locking rod allowing change of a posture thereof and a manipulation member capable of being pressed by user manipulation, and a posture of the manipulation member is changed to one of a posture allowing movement of the door button in a straight direction and a posture restricting movement of the door button in the straight direction.

In order to achieve the above and other aspects of the present disclosure, a cooking appliance according to one embodiment of the present disclosure includes: a locking mechanism selectively preventing backward movement of a door button adapted to open a door, wherein the locking mechanism includes a locking rod allowing change of a posture thereof and a manipulation button provided to a button housing so as to move in a straight direction to rotate therein, and a posture of the manipulation member is changed to one of a posture allowing the manipulation button to move in a straight direction and a posture restricting movement of the manipulation button in the straight direction with the button housing upon rotation of the manipulation button.

With this structure, the cooking appliance allows a user to select use of the dual door-securing function for stably securing the door, as needed.

When the locking rod is in a posture restricting backward movement of the door button, at least a portion of the locking rod may be disposed on a movement path of the door button.

When the locking rod is in a posture restricting backward movement of the door button, the locking rod may deviate from the movement path of the door button.

With this structure, the cooking appliance requires release of the door button from a restricted state in order to allow manipulation for opening the door, thereby preventing unintentional opening of the cooking chamber during operation.

In order to achieve the above and other aspects of the present disclosure, a cooking appliance according to one embodiment of the present disclosure includes: a locking mechanism selectively preventing backward movement of a door button adapted to open a door, wherein the locking mechanism includes a locking rod allowing change of a posture thereof and a manipulation button capable of being pressed by user manipulation, the manipulation button changing the posture of the locking rod to a posture restricting the backward movement of the door button and a posture allowing the backward movement of the door button.

With this structure, the cooking appliance allows a user to select use of a dual door-securing function for stably securing the door, as needed.

The manipulation button may be integrally formed with the locking rod.

With this structure, the cooking appliance may have a reduced number of components and may improve manipulation accuracy.

In order to achieve the above and other aspects of the present disclosure, a cooking appliance according to one embodiment of the present disclosure includes: a locking mechanism selectively preventing backward movement of a door button adapted to open a door, wherein the locking mechanism includes a locking rod allowing change of a posture thereof, a manipulation button capable of being pressed by user manipulation, and a securing member holding the posture of the locking rod.

The securing member may be coupled to a side surface of a control panel disposed at a side of the door and protruding towards the locking rod through the side surface of the control panel.

With this structure, the cooking appliance allows a user to select use of the dual door-securing function for stably securing the door, as needed.

In accordance with one aspect of the present disclosure, a cooking appliance includes:

a main body having a cooking chamber therein and open at a front side thereof; a door provided to the front side of the main body and rotatably coupled to the main body to open or close the cooking chamber; a latch mechanism provided to the door to be selectively coupled to the main body and coupled to the main body to secure the door at a closed position; a door button capable of being pressed by user manipulation and moved to a pressed position to separate the latch mechanism from the main body when pressed by user manipulation; and a locking mechanism selectively restricting movement of the door button.

The locking mechanism may include: a locking rod allowing change of a posture thereof to a locking posture restricting movement of the door button to the pressed position and an unlocking posture allowing movement of the door button to the pressed position; and a manipulation member capable of being pressed by user manipulation and changing the posture of the locking rod from the locking posture to the unlocking posture when pressed by user manipulation.

The manipulation member may include a button housing coupled to the main body and a manipulation button inserted into the button housing to be movable in a straight direction and to be rotatable in the button housing.

The manipulation button may be moved in the straight direction to change the posture of the locking rod when pressed by user manipulation.

A posture of the manipulation member may be changed to one of a posture allowing movement of the manipulation button in the straight direction and a posture restricting movement of the manipulation button in the straight direction upon rotation of the manipulation button,.

The manipulation button may include: a pressing plane capable of being pressed by user manipulation; and a fitting shaft protruding from the pressing plane and inserted into a hollow space of the button housing.

The fitting shaft may be coupled to the interior of the button housing to be movable in the straight direction and to be rotatable therein and may connect with the locking rod to change the posture of the locking rod.

The button housing may be provided with a latch groove concavely formed on one end of the button housing in a movement direction of the manipulation button and the manipulation button may further include a latch protrusion protruding from the fitting shaft in a circumferential direction thereof to be inserted into the latch groove.

The latch protrusion may be moved along the fitting shaft in the straight direction to one of an insertion position at which the latch protrusion is inserted into the latch groove and a separation position at which the latch protrusion is separated from the latch groove.

The fitting shaft may push the locking rod to change the posture of the locking rod from the locking posture to the unlocking posture.

When the posture of the locking rod is changed to the unlocking posture, the latch protrusion may be moved to the separation position.

The manipulation member may further include a resilient member providing resilient force for returning the manipulation button from a pressed state to the original position.

The button housing may be provided at one end thereof with a latch step blocking movement of the latch protrusion from the separation position towards the insertion position.

The latch groove and the latch step may be disposed in a rotational direction of the manipulation button.

The button housing may further include a rotation-suppressing protrusion disposed between the latch groove and the latch step and protruding from one end of the button housing beyond the latch step.

The manipulation button may further include a manipulation groove formed in a concave shape on the pressing plane.

The door button may include a pressing plane capable of being pressed by user manipulation and an edge protrusion extending backward from a lateral edge of the pressing plane.

When the locking rod has the unlocking posture, the locking mechanism may be placed outside the door button in the lateral direction thereof.

When the locking rod has the locking posture, at least a portion of the locking rod may be disposed on a movement path of the edge protrusion.

When the locking rod has the locking posture, at least a portion of the locking rod may be disposed on a movement path of the door button.

When the locking rod has the unlocking posture, the locking rod may deviate from the movement path of the door button.

The locking rod may include: a rotational shaft disposed to rotate about a forward-backward axis; a locking protrusion restricting movement of the door button from behind the door button at a locking position while allowing movement of the door button at an unlocking position, the locking protrusion being connected to the rotational shaft to move between the locking position and the unlocking position in conjunction with a rotation of the rotational shaft; and a connection protrusion extending from the rotational shaft to connect with the manipulation button and moved to rotate the rotational shaft in conjunction with movement of the manipulation button.

The connection protrusion may protrude from the rotational shaft in a circumferential direction of the rotational shaft; the manipulation button may be disposed at one lateral side of the connection protrusion to move in a lateral direction; and the connection protrusion may be moved in a rotational direction of the rotational shaft in conjunction with lateral movement of the manipulation button.

The cooking appliance may further include a control panel disposed at a front side of the main body to be placed at one side of the door and the manipulation member may be disposed on a side surface of the control panel.

The control panel may be formed with a manipulation member-insertion hole formed through the side surface thereof in a lateral direction thereof; the button housing may be inserted into the manipulation member-insertion hole to be coupled to the side surface of the control panel; and the manipulation button may be provided to the button housing to move in the lateral direction.

The manipulation member may include a hook member having a protrusion protruding from the button housing in the circumferential direction thereof and the hook member may be resiliently deformable in a radial direction of the button housing.

The locking rod may include: a rotational shaft disposed to rotate about a forward-backward axis; a first locking protrusion restricting movement of the door button at a first locking position while allowing movement of the door button at a first unlocking position, the first locking protrusion being connected to the rotational shaft to move between the first locking position and the first unlocking position in conjunction with a rotation of the rotational shaft; and a first connection protrusion extending from the rotational shaft to connect with the manipulation button and moved to rotate the rotational shaft in conjunction with movement of the manipulation button.

The first connection protrusion may protrude from the rotational shaft in the circumferential direction of the rotational shaft; the manipulation button may be disposed at one side of the first connection protrusion to move in a lateral direction of the first connection protrusion; and the first connection protrusion may be moved in a rotational direction of the rotational shaft in conjunction with lateral movement of the manipulation button.

The first locking protrusion and the first connection protrusion may protrude from the rotational shaft in the circumferential direction of the rotational shaft to protrude in different directions, respectively.

The locking rod may further include a second latch protrusion restricting movement of the door button at a second locking position when the first locking protrusion is placed at the first locking position.

The second latch protrusion may protrude from the rotational shaft in the circumferential direction of the rotational shaft in a different direction from a protruding direction of the first locking protrusion.

The locking rod may further include a third latch protrusion restricting movement of the door button at a third locking position when the first latch protrusion is placed at the first locking position.

The third latch protrusion may protrude from the first connection protrusion in a different direction from a protruding direction of the first connection protrusion.

The door button may include a pressing plane capable of being pressed by user manipulation and first to third backward protrusions protruding backward from the pressing plane.

The first latch protrusion may be disposed on a movement path of the first backward protrusion at the first locking position, the second latch protrusion may be disposed on a movement path of the second backward protrusion at the second locking position, and the third latch protrusion may be disposed on a movement path of the third backward protrusion at the third locking position.

The first backward protrusion may be spaced apart from the second backward protrusion in a lateral direction and at least one of the first backward protrusion and the second backward protrusion may be spaced apart from the third backward protrusion in a vertical direction.

A pressing protrusion may be moved in the rotational direction of the rotational shaft in conjunction with forward-backward movement of the manipulation button.

The manipulation button may be brought into contact with the pressing protrusion in a front-rear direction and at least one of a rear end of the manipulation button facing the pressing protrusion and a front end of the pressing protrusion facing the manipulation button may be formed with a beveled plane.

The rear end of the manipulation button may move the pressing protrusion in the rotational direction of the rotational shaft while sliding along the beveled plane or the pressing protrusion may be moved in the rotational direction of the rotational shaft while the front end of the pressing protrusion slides along the beveled plane.

The beveled plane may include a first beveled plane formed on the front end of the pressing protrusion facing the manipulation button, the first beveled plane defining a plane gradually beveled backward in the circumferential direction of the rotational shaft.

The beveled plane may include a second beveled plane formed on the rear end of the manipulation button facing the pressing protrusion and the second beveled plane may define a plane parallel to the first beveled plane.

The inner surface may be formed with a passing hole disposed between the manipulation button and a door button insertion hole and formed therethrough in the lateral direction.

At the locking position, at least a portion of the locking rod may protrude to a region between the door button insertion hole and the edge protrusion of the door button through the passing hole.

When the door button is moved to the pressed position, a pushing protrusion may push the transmission panel in a backward direction to move the power transmission panel to the uncoupling position.

When the power transmission panel is moved to the uncoupling position, the transmission shaft may be rotated in one direction to release engagement between the latch mechanism and the main body.

The control panel may include a front surface forming a plane parallel to the door, a door button-insertion hole penetrating the front side in the front-rear direction, and a rear support plane formed inside the door button-insertion hole to define a plane disposed behind the front surface.

The rear support plane may be disposed between the pressing plane and the transmission panel, and the pushing protrusion may connect with the transmission panel through the rear support plane.

The control panel may further include a support boss protruding from the rear support plane in the front-rear direction and having a hollow space therein.

The pushing protrusion may be movably coupled to the support boss and pass through the rear support plane.

The locking rod-securing member may include: a protruding boss connected to the latch protrusion; a securing protrusion coupled to the protruding boss to be movable in the front-rear direction, at least a portion of the securing protrusion protruding from the protruding boss towards the transmission panel; and a resilient member providing resilient force forcing the securing protrusion to move towards the transmission panel.

The securing protrusion may be coupled to the transmission panel such that the locking rod-securing member is coupled to the transmission panel.

The front surface of the transmission panel facing the securing protrusion may be formed with a securing groove in a backward direction and the securing protrusion may be inserted into the securing groove to be coupled to the transmission panel when the latch protrusion is placed at the unlocking position.

In accordance with another aspect of the present disclosure, a cooking appliance includes: a main body having a cooking chamber therein and open at a front side thereof; a door provided to the front side of the main body and rotatably coupled to the main body to open or close the cooking chamber; a latch mechanism provided to the door to be selectively coupled to the main body and coupled to the main body to secure the door at a closed position; a door button capable of being pressed by user manipulation and rotated about one lateral side to move to a pressed position when pressed by user manipulation, the door button separating the latch mechanism from the main body at the pressed position; and a locking mechanism selectively restricting movement of the door button.

The locking mechanism may include: a locking rod allowing change of a posture thereof to a locking posture restricting movement of the door button to the pressed position and an unlocking posture allowing movement of the door button to the pressed position; and a manipulation member capable of being pressed by user manipulation and changing the posture of the locking rod from the locking posture to the unlocking posture when pressed by user manipulation.

The manipulation button may be integrally formed with the locking rod.

The locking rod may rotate about a forward-backward axis while changing the posture thereof.

The manipulation button may be disposed at one lateral side of the locking rod and may press the locking rod at one lateral side to rotate the locking rod.

The locking rod may include: a rotational shaft disposed to rotate about a forward-backward axis; a locking protrusion restricting movement of the door button at a rear side thereof at a locking position while allowing movement of the door button at an unlocking position, the locking protrusion being connected to the rotational shaft to move to the locking position and the unlocking position in conjunction with rotation of the rotational shaft; and a connection protrusion extending from the rotational shaft to connect with the manipulation button and moved to rotate the rotational shaft in conjunction with a movement of the manipulation button.

The connection protrusion may protrude from the rotational shaft in a circumferential direction of the rotational shaft.

The manipulation button may be disposed at one lateral side of the connection protrusion to move in the lateral direction thereof.

The connection protrusion may be moved in a rotational direction of the rotational shaft in conjunction with lateral movement of the manipulation button.

The manipulation button may be integrally formed with the connection protrusion.

The locking mechanism may further include a securing member holding the posture of the locking rod to the unlocking posture.

The securing member may contact the connection protrusion between the rotational shaft and the manipulation button to support the connection protrusion at one side in the lateral direction.

The cooking appliance may further include a control panel disposed at a front side of the main body to be placed at one side of the door.

The securing member may be coupled to a side surface of the control panel and protrude towards the connection protrusion through the side surface of the control panel.

The door button may include: a pressing plane capable of being pressed by user manipulation; and an edge protrusion extending backwards from a lateral edge of the pressing plane.

When the locking rod has the unlocking posture, the locking mechanism may be placed outside the door button in the lateral direction thereof.

When the locking rod has the locking posture, at least a portion of the locking rod may be disposed on a movement path of the edge protrusion.

The control panel may be formed with a door button-insertion hole penetrating the control panel in the lateral direction and the door button may be inserted into the door button-insertion hole to be movable inside the control panel in the lateral direction.

The control panel may include a front surface forming a plane parallel to the door; and an inner surface extending backward from the front surface and surrounding the door button-insertion hole.

The edge protrusion may extend backward from the pressing plane while forming a plane parallel to the inner surface.

The cooking appliance may further include a power transmission panel capable of moving between a coupling position and an uncoupling position.

The power transmission panel may allow engagement between the latch mechanism and the main body at the coupling position and may release engagement between the latch mechanism and the main body at the uncoupling position.

The door button may be moved to the pressed position to move the power transmission panel to the unlocking position.

The door button may include a pressing plane capable of being pressed by user manipulation and a pushing protrusion protruding backward from the pressing plane.

The power transmission panel may include a transmission shaft disposed to rotate about a lateral axis and connected to the latch mechanism and a transmission panel connected to the transmission shaft to be placed at a rear side of the pressing protrusion to rotate about one side thereof connected to the transmission shaft in the front-rear direction.

The pushing protrusion may be connected to the transmission panel to rotate the transmission panel in a backward direction.

The locking rod may include: a rotational shaft disposed to rotate about a forward-backward axis; and a latch protrusion restricting movement of the door button at a rear side thereof at a locking position while allowing movement of the door button at an unlocking position, the latch protrusion being connected to the rotational shaft to move between the locking position and the unlocking position in conjunction with rotation of the rotational shaft.

The locking rod may further include a locking rod-securing member extending from the rotational shaft to connect with the transmission panel.

The locking rod-securing member may be moved in conjunction with movement of the latch protrusion and may be coupled to the transmission panel to secure the locking rod to the transmission panel when the latch protrusion is placed at the unlocking position.

In the cooking appliance according to the present disclosure, the door may be locked with high reliability by the locking mechanism disposed to lock the door to the main body such that the door may maintain the cooking chamber in a closed state, thereby effectively preventing unintentional opening of the cooking chamber during operation of the cooking appliance.

In addition, the cooking appliance according to the present disclosure allows easy and convenient locking and unlocking of the door through convenient manipulation of the manipulation button.

Further, the cooking appliance according to the present disclosure allows automatic locking operation of the locking mechanism with respect to the door closing the cooking chamber even without separate manipulation, thereby improving stability of the cooking appliance and convenience in manipulation thereof.

Further, the cooking appliance according to the present disclosure suppresses frequent unnecessary opening/closing of the door through easy and convenient locking and unlocking of the door, thereby effectively suppressing unstable opening/closing operation of the door due to the latch mechanism wearing out prematurely.

Further, the cooking appliance according to the present disclosure provides a two-stage locking function requiring at least two operations for opening the door while allowing the two-stage locking function to be easily and conveniently released when the two-stage locking function becomes unnecessary, thereby improving both stability and convenience of the cooking appliance.

In the cooking appliance according to the present disclosure, the manipulation button is integrally formed with the locking rod, thereby facilitating management and assembly of components and achieving reduction in time and cost for assembly while improving manipulation accuracy through the manipulation button.

### DRAWINGS

FIG. 1 is a perspective view of a cooking appliance according to an embodiment of the present disclosure.

FIG. 2 is a perspective view of the cooking appliance shown in FIG. 1, in which a door is open.

FIG. 3 is a perspective view of a control panel separated from the cooking appliance shown in FIG. 1.

FIG. 4 is a front exploded perspective view of a locking mechanism and the control panel shown in FIG. 3.

FIG. 5 is a rear exploded perspective view of the locking mechanism and the control panel shown in FIG. 3.

FIG. 6 is an enlarged rear view of a door button shown in FIG. 3.

FIG. 7 is a cross-sectional view of a manipulation member shown in FIG. 6.

FIG. 8 is a cross-sectional view of a locking mechanism according to a first embodiment of the present disclosure.

FIG. 9 is a sectional perspective view of the locking mechanism according to the first embodiment of the present disclosure.

FIG. 10 is a partially enlarged view of a door button and the locking mechanism shown in FIG. 9.

FIG. 11 is a rear view illustrating an unlocking state of the locking mechanism shown in FIG. 6.

FIG. 12 is a cross-sectional view of the locking mechanism shown in FIG. 10.

FIG. 13 is a rear view illustrating a transmission panel and a locking rod-securing member when a locking rod is placed at a locking position.

FIG. 14 is a front view of the transmission panel excluding the locking rod-securing member shown in FIG. 13.

FIG. 15 is a cross-sectional view taken along line XV-XV of FIG. 13.

FIG. 16 is a front view illustrating the transmission panel and the locking rod-securing member when the locking rod is placed at an unlocking position.

FIG. 17 is a cross-sectional view taken along line XVII-XVII of FIG. 16.

FIG. 18 is a cross-sectional view of the power transmission panel of FIG. 17 moved to an uncoupling position.

FIG. 19 is a rear perspective view illustrating a locking state of the locking mechanism according to the first embodiment of the present disclosure.

FIG. 20 is a rear perspective view illustrating an unlocking state of the locking mechanism shown in FIG. 19.

FIG. 21 is a rear perspective view illustrating a function-release state of the locking mechanism shown in FIG. 20.

FIG. 22 is an exploded front perspective view of a control panel and a locking mechanism according to a second embodiment of the present disclosure.

FIG. 23 is an exploded rear perspective view of the control panel and the locking mechanism according to the second embodiment of the present disclosure.

FIG. 24 is an enlarged front view of a door button according to the second embodiment of the present disclosure.

FIG. 25 is a cross-sectional perspective view taken along line XXVI-XXVI of FIG. 24.

FIG. 26 is a cross-sectional view taken along line XXVI-XXVI of FIG. 24.

FIG. 27 is a front view illustrating an unlocking state of the locking mechanism shown in FIG. 24.

FIG. 28 is a cross-sectional view taken along line XXVIII-XXVIII of FIG. 27.

FIG. 29 is a front view illustrating a transmission panel and the locking mechanism when the locking rod is placed at a locking position.

FIG. 30 is a front view illustrating the transmission panel and the locking mechanism when the locking rod is placed at an unlocking position.

FIG. 31 is a cross-sectional view taken along line XXXI-XXXI of FIG. 30.

FIG. 32 is a cross-sectional view of the power transmission panel of FIG. 31 moved to an uncoupling position.

FIG. 33 is a perspective view of a control panel separated from a cooking appliance according to a third embodiment of the present disclosure.

FIG. 34 is an exploded front perspective view of the control panel and a locking mechanism shown in FIG. 33.

FIG. 35 is an exploded rear perspective view of the control panel and the locking mechanism shown in FIG. 33.

FIG. 36 is a partially enlarged front view of a door button shown in FIG. 33.

FIG. 37 is a cross-sectional view taken along line XXXVII-XXXVII of FIG. 36.

FIG. 38 is a cross-sectional view taken along line XXXVIII-XXXVIII of FIG. 36.

FIG. 39 is a cross-sectional view taken along line XXXIX-XXXIX of FIG. 36.

FIG. 40 is a front view illustrating an unlocking state of the locking mechanism shown in FIG. 36.

FIG. 41 is a cross-sectional view taken along line XXXXI-XXXXI of FIG. 40.

FIG. 42 is a cross-sectional view taken along line XXXXII-XXXXII of FIG. 40.

FIG. 43 is a perspective view of a control panel separated from a cooking appliance according to a fourth embodiment of the present disclosure.

FIG. 44 is an exploded front perspective view of the control panel and a locking mechanism shown in FIG. 43.

FIG. 45 is an exploded rear perspective view of the control panel and the locking mechanism shown in FIG. 43.

FIG. 46 is an enlarged rear perspective view of a door button shown in FIG. 43.

FIG. 47 is a cross-sectional view of a manipulation button shown in FIG. 46.

FIG. 48 is a cross-sectional view of the locking mechanism according to the fourth embodiment of the present disclosure.

FIG. 49 is a sectional perspective view of the locking mechanism according to the fourth embodiment of the present disclosure.

FIG. 50 is a partially enlarged view of the door button and the locking mechanism shown in FIG. 49.

FIG. 51 is a rear perspective view illustrating an unlocking state of the locking mechanism shown in FIG. 46.

FIG. 52 is a rear view illustrating the unlocking state of the locking mechanism shown in FIG. 46.

FIG. 53 is a cross-sectional view of the locking mechanism shown in FIG. 50.

FIG. 54 is a rear view illustrating a function-release state of the locking mechanism shown in FIG. 52.

FIG. 55 is a cross-sectional view illustrating the function-release state of the locking mechanism shown in FIG. 54.

### DETAILED DESCRIPTION

The above and other aspects, features, and advantages of the present disclosure may become apparent from the detailed description of the following embodiments in conjunction with the accompanying drawings. Description of known functions and constructions which may unnecessarily obscure the subject matter of the present disclosure may be omitted. Reference will now be made in detail to various embodiments, examples of which are illustrated in the accompanying drawings such that the present disclosure may be easily implemented by those skilled in the art. Like components may be denoted by like reference numerals throughout the specification.

It should be understood that, although the terms “first”, “second”, and the like may be used herein to describe various elements and the like, these elements should not be limited by these terms. These terms are generally used to distinguish one element from another element. Thus, a first element discussed below could be termed a second element, or vice versa, without departing from the scope of the present disclosure.

It should be understood that the present disclosure is not limited to the following embodiments and may be embodied in different ways by those skilled in the art without departing from the scope of the present disclosure, and that the embodiments are given to provide complete disclosure of the present disclosure and to provide a thorough understanding of the present disclosure to those skilled in the art. However, it should be understood that the present disclosure is not limited to the following embodiments and that various modifications, substitutions, and equivalent embodiments can be made by those skilled in the art without departing from the spirit and scope of the present disclosure.

It should be understood that the accompanying drawings are provided for easy understanding of the embodiments disclosed herein and the technical spirit of the present disclosure disclosed herein includes all modifications, equivalents and substitutions of the present disclosure without being limited by the accompanying drawings. It should be understood that the drawings may not be to precise scale and may be exaggerated or scaled down, and thus should not be construed as limiting the scope of the present disclosure.

The terminology is used herein for the purpose of describing particular embodiments and is not intended to be limiting of the present disclosure. As used herein, the singular forms “a” and “an” are intended to include the plural forms as well, unless the context clearly indicates otherwise. It should be understood that the terms “comprises” and/or “comprising,” when used in this specification, specify the presence of stated features, steps, operations, elements, and/or components, but do not preclude the presence or addition of one or more other features, steps, operations, elements, components, and/or groups.

It should be understood that, although the terms “first”, “second”, and the like may be used herein to describe various elements and the like, these elements should not be limited by these terms. These terms may be used to distinguish one element from another element.

It should be understood that when an element is referred to as being “connected” to or “on” another element, it may be directly on the other element, or intervening elements may also be present. In contrast, when an element is referred to as being “directly connected” to or “directly on” or another element, there are no intervening elements present.

It should be understood that, when a component is referred to as being disposed “at an upper (lower) portion of” or “on (or “under”) another component, it may be directly formed to adjoin an upper surface (“a lower surface”) of the other component, or intervening component(s) may also be interposed therebetween.

Unless otherwise defined herein, all terms including technical or scientific terms used herein have the same meanings as commonly understood by those skilled in the art to which the present disclosure belongs. It should be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

With a cooking appliance placed on the floor, a direction in which a door is disposed is defined as the front with reference to the center of the cooking appliance. Accordingly, a direction of opening the door and entering the cooking appliance is defined as the rear. For convenience, a direction towards the front and the rear may be referred to as a first direction. Then, the front may be referred to as one side in the first direction and the rear may be referred to as the other side in the first direction.

In addition, the direction of gravity may be defined as a downward direction and a direction opposite to the direction of gravity may be defined as an upward direction.

Further, a horizontal direction orthogonal to the front-rear direction of the cooking appliance, that is, a width direction of the cooking appliance when looking at the cooking appliance from the front of the door thereof, may be referred to as a left-right direction. For convenience, the left-right direction may be referred to as a second direction. Then, the right side may be referred to as one side in the second direction and the left side may be referred to as the other side in the second direction.

The width direction of the cooking appliance may be referred to as a lateral direction. Then, the right side may be referred to as one side in the lateral direction and the left side may be referred to as the other side in the lateral direction.

Further, an up-down direction may be referred to as a third direction. Then, an upper side may be referred to as one side in the third direction and a lower side may be referred to as the other side in the third direction.

Further, the up-down direction may be referred to as a transverse direction. Then, all of the front-rear direction and the right-left direction, that is, the first direction and the second direction, may be referred to as a longitudinal direction.

As used herein, unless the context clearly indicates otherwise, the term “and/or” means A, B, or A and B, and the term “C to D” means “greater than or equal to C and less than or equal to D.”

[Overall Structure of Cooking Appliance]

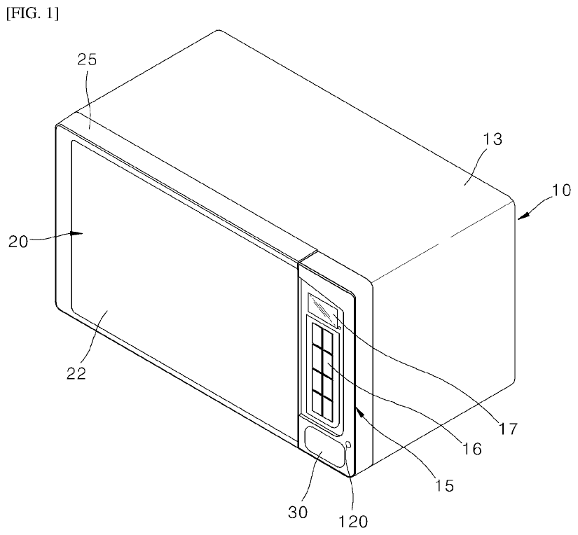

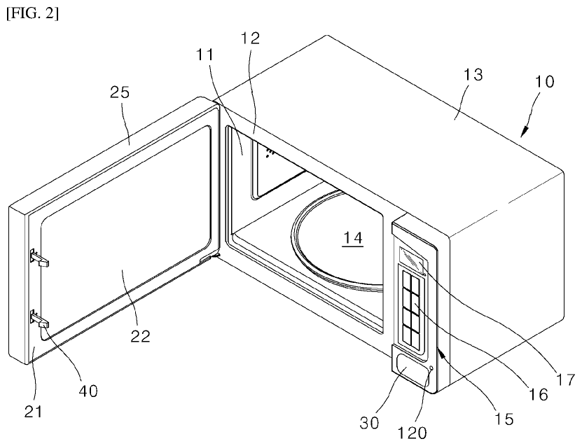

FIG. 1 is a perspective view of a cooking appliance according to a first embodiment of the present disclosure and FIG. 2 is a perspective view of the cooking appliance shown in FIG. 1, in which a door is open.

Referring to FIG. 1 and FIG. 2, the cooking appliance according to the first embodiment has an external appearance defined by a main body 10. The main body 10 may have a generally parallelepiped shape and may be formed of a material having a level of strength to protect many components therein. The main body 10 may be composed of a cavity 11 and a cabinet 13.

The cavity 11 may form an interior frame of the main body 10. The cavity 11 may have a parallelepiped shape open at a front side thereof. The cavity 11 may have a cooking chamber 14 therein. The cooking chamber 14 may have a shape corresponding to an interior shape of the cavity 11, that is, a parallelepiped shape open at the front side thereof.

The cooking chamber 14 may have a parallelepiped shape open at the front side thereof. With the cooking chamber 14 closed, cooking may be performed while heating the interior space of the cooking chamber 14. That is, in the cooking appliance, the interior space of the cooking chamber 14 becomes a space in which food is substantially cooked.

The cabinet 13 may define an external appearance of the main body 10 outside the cavity 11. The cabinet 13 may define the external appearance of the main body 10 while covering an upper portion and lateral sides of the cavity 11.

In this embodiment, a front plate 12 is disposed at the front side of the cavity 11.

The front plate 12 may define an external appearance of the main body 10 at the front side of the cavity 11. By way of example, the front plate 12 may be realized in a form of a metal plate having a hollow space therein.

A door 20 may be rotatably provided to a front side of the main body 10 to selectively open or close the cooking chamber 14. The door 20 may open and close the cooking chamber 14 in a side-swing manner in which the door is rotated right and left about one lateral side thereof. For example, the door 20 may close the cooking chamber 14 at a closed position and may be rotated from the closed position to open the cooking chamber 14.

The door 20 may have a parallelepiped shape having a predetermined thickness. A hinge may be disposed between the main body 10 and the door. The hinge may be disposed at one lateral side of the main body 10 such that the door 20 can be rotatably coupled at one side thereof to the main body 10 through the hinge. The door 20 may be rotatably coupled to the hinge at the front side of the main body 10 and may rotate about the hinge to open or close the cooking chamber 14.

A cooking chamber heat source may be disposed inside the main body 10 to heat the interior of the cooking chamber 14. The cooking chamber heat source may be realized by one type of heat source or at least two types of heat sources.

In this embodiment, a cooking chamber heat source may be a magnetron capable of supplying high frequency heat into the cooking chamber 14. The magnetron may be disposed inside the main body 10 and placed at an upper portion of the cooking chamber 14 or at one side thereof.

The main body 10 may be formed with an electric chamber, which is placed at an upper portion of the cooking chamber 14 or at one side thereof inside the main body 10. In this embodiment, the electric chamber is disposed at one side of the cooking chamber 14. The electric chamber may be provided with electronic components, such as a magnetron, a high voltage transmitter, and the like.

The main body 10 may be provided with a control panel 15 at the front side of the main body 10. The control panel 15 may be disposed at a front side of the cavity 11 in a region that does not overlap with the cooking chamber 14 in the front-rear direction. For example, the electric chamber may be disposed at one side of the cooking chamber 14 and the control panel 15 may be disposed at a front side of the electric chamber.

The control panel 15 may have a parallelepiped shape having an interior space and the control panel 15 may be provided with an input unit 16 at the front side of the control panel 15 through which a user may input a manipulation signal for operation of the cooking appliance.

The input unit 16 may be provided with multiple manipulation switches, with which a user may directly input manipulation signals.

The control panel 15 may be further provided with a display 17 that displays operation data of the door, operation data of the cooking appliance, cooking data of food, and the like, and a user can check various data relating to the cooking appliance through the display 17.

Furthermore, the control panel 15 may be provided with a door button 30. In this embodiment, the door button 30 is disposed below the display 17 and the input unit 16. The door button 30 may act as a switch for opening the door 20.

In this embodiment, the door button 30 is provided in a form of a push button. In this case, when the door button 30 is pressed, a latch mechanism 40 described below may separate from a structure, which holds the latch mechanism, to open the door 20.

In another embodiment, the door button 30 may be realized by an electronic button.

Alternatively, the door 20 may have a structure capable of being opened or closed without the door button 30, thus there may be various modifications of the structure for opening the door 20.

[Structure of Door]

The door 20 may include a door panel 21 that forms a framework of the door 20. The door panel 21 may have a parallelepiped shape corresponding to a front shape of the main body 10. The door panel 21 may be formed with an open window 22 through which the interior of the cooking chamber 14 can be observed with the naked eye. In this embodiment, the door panel 21 is formed of a metallic material having a level of strength.

In addition, the door 20 may be provided with a door frame 25 outside the door panel 21. The door frame 25 defines a front surface, an upper surface, a lower surface, and side surfaces of the door 20, and may have a parallelepiped shape open at a rear side thereof. The door frame 25 may receive the door panel 21 therein.

Further, the door frame 25 is provided at one lateral side thereof with hinges, which couple the door panel 21 to the main body 10 such that the door panel 21 can rotate about the hinges. The hinges may be provided to upper and lower ends of the door frame 25 at one lateral side thereof.

The cooking appliance may further include the latch mechanism 40. The latch mechanism 40 may be provided to secure the door 20 at a closed position with respect to the main body 10.

In this embodiment, the latch mechanism 40 is provided at the door 20. The latch mechanism 40 provided at the door 20 may be inserted into the main body 10 through latch slots, which are formed through a front surface of the main body 10, when the door 20 closes on the cooking chamber 14.

As such, the latch mechanism 40 inserted into the main body 10 may engage with a latch structure disposed inside the main body 10 to selectively secure the door 20 to the main body 10.

Opening of the door 20 with respect to the main body 10 is restricted by such operation of the latch mechanism 40, whereby the cooking chamber 14 may be substantially maintained in a shielded state by the door 20. In addition, whether the door 20 is closed may be detected through detection of engagement between the latch mechanism 40 and the latch structure, whereby operation of the cooking appliance can be controlled so as to prevent cooking from proceeding when the door is open.

The cooking appliance may further include a locking mechanism 300. The locking mechanism 300 serves to secure the door 20 at the closed location together with the latch mechanism 40.

The locking mechanism 300 may be disposed to secure the door button 30 so as to prevent manipulation of the door button 30. The locking mechanism 300 may be provided at the control panel 15 to be placed near the door button 30.

For example, the locking mechanism 300 may be disposed at a lower side of the control panel 15 and at a rear side of the door button 30. The locking mechanism 300 is disposed to restrict movement of the door button 30. When manipulation of the door button 30 is not performed, the door 20 is not opened. Accordingly, the locking mechanism 300 may restrict movement of the door button 30, thereby restricting the opening of the door 20.

In the cooking appliance according to this embodiment, the door 20 may be dually locked by the latch mechanism 40 and the locking mechanism 300. That is, in the cooking appliance according to this embodiment, engagement between the latch mechanism 40 and the main body 10 is released together with coupling between the locking mechanism 300 and the door button 30 in order to allow the door 20 to open the cooking chamber 14.

[Structure of Door Button and Peripheries thereof]

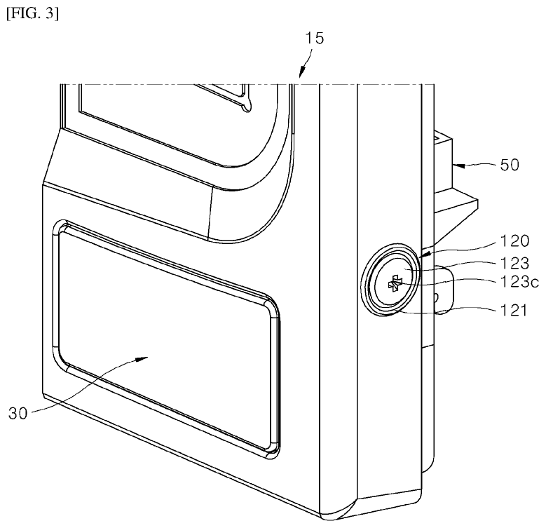

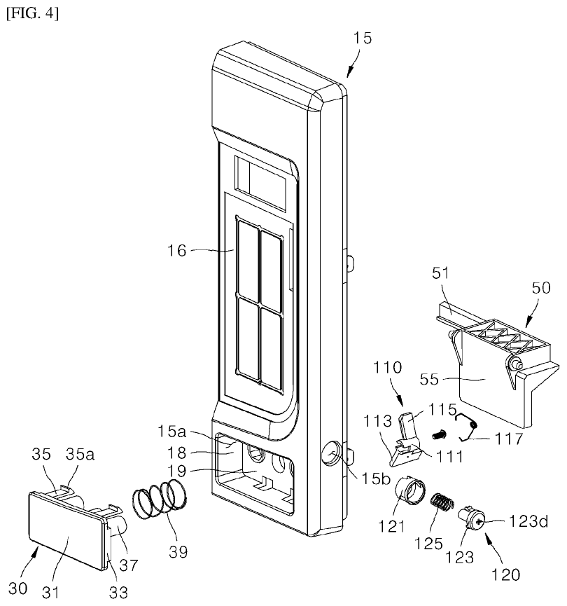

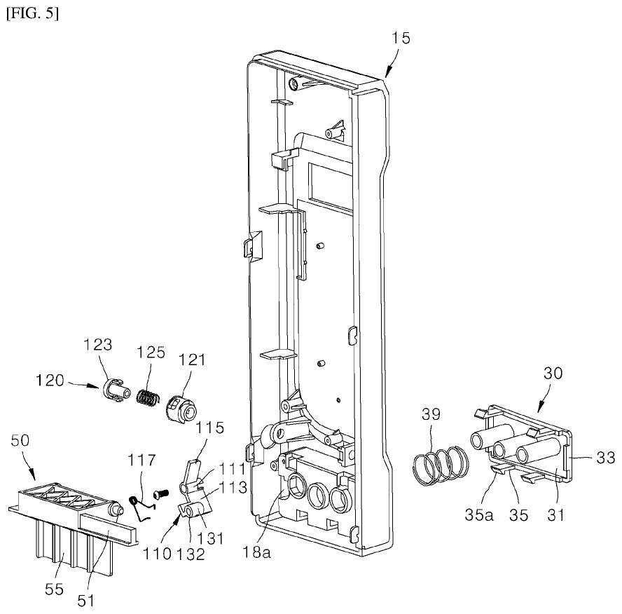

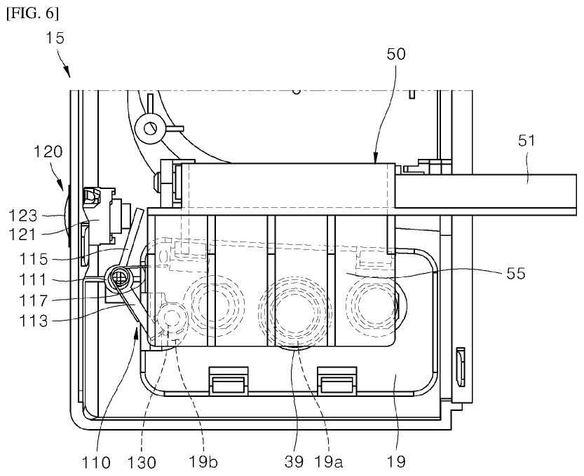

FIG. 3 is a perspective view of the control panel separated from the cooking appliance shown in FIG. 1 and FIG. 4 is a front exploded perspective view of the locking mechanism and the control panel shown in FIG. 3. Further, FIG. 5 is a rear exploded perspective view of the locking mechanism and the control panel shown in FIG. 3 and FIG. 6 is an enlarged rear view of the door button shown in FIG. 3.

Referring to FIG. 3 to FIG. 6, the door button 30 may be provided at the control panel 15 and may be pressed by user manipulation. When pressed by user manipulation, the door button 30 moves to a pressed position to separate the latch mechanism 40 from the main body 10, more specifically from the latch structure of the main body 10.

The control panel 15 may be provided with a door button-insertion hole 15a. The door button-insertion hole 15a may be disposed at a lower portion of the control panel 15 to pass through the control panel 15 in the front-rear direction.

The door button 30 may be inserted into the door button-insertion hole 15a to be movable in the control panel 15 in the front-rear direction. The door button 30 may include a pressing plane 31 and an edge protrusion 33.

The pressing plane 31 corresponds to a front surface of the door button 30, which may be pressed by user manipulation. The pressing plane 31 may form a flat plane parallel to the front surface of the control panel 15. The edge protrusion 33 may extend backwards from a lateral edge of the pressing plane 31.

The control panel 15 may include a front surface forming a front external appearance of the control panel 15 and side surfaces extending backwards from front edges of the control panel 15. The front surface of the control panel 15 may form a plane parallel to the door 20. The front surface of the control panel 15 may be provided with the input unit 16 and the display 17.

The door button-insertion hole 15a may be formed through the front surface of the control panel 15 in the front-rear direction. In addition, an inner surface 18 of the control panel 15 may be formed around the door button-insertion hole 15a. The inner surface 18 of the control panel 15 may form an inner wall of the control panel 15, which extends backward from the front surface of the control panel 15 so as to enclose the door button-insertion hole 15a.

The edge protrusion 33 of the door button 30 may extend backward from the pressing plane 31 while forming a plane parallel to the inner surface 18 of the control panel 15. The edge protrusion 33 of the door button 30 may be slidably coupled to the inner surface 18 of the control panel 15 in the front-rear direction. Accordingly, the door button 30 may be provided at the control panel 15 that is pressable by user manipulation.

The control panel 15 may further include a rear support plane 19. The rear support plane 19 may be disposed inside the door button-insertion hole 15a and may form a plane inside the door button-insertion hole 15a to be disposed behind the front surface of the control panel 15.

The door button 30 may be coupled to the rear support plane 19 to be supported by the control panel 15. By way of example, the door button 30 may be coupled to the rear support plane 19 through a fitting protrusion 35.

The fitting protrusion 35 may protrude backward from the pressing plane 31. The door button 30 may be provided with a plurality of fitting protrusions 35. For example, the door button 30 may be provided at an upper end thereof with a pair of fitting protrusions 35 spaced apart from each other in the lateral direction and at a lower end thereof with a pair of fitting protrusions 35 spaced apart from each other in the lateral direction.

Each of the fitting protrusions 35 may pass through the rear support plane 19 and may be coupled to the rear support plane 19 to be movable in the front-rear direction. By coupling between the fitting protrusions 35 and the rear support plane 19, the door button 30 may be coupled to the control panel 15 to be movable in the front-rear direction.

Each of the fitting protrusions 35 may be provided at a rear end thereof with a hook protrusion 35a. The hook protrusion 35a may protrude from the rear end of the fitting protrusion 35 in the up-down direction or in the lateral direction. For example, the hook protrusion 35a formed on the fitting protrusion 35 disposed at the upper end of the door button 30 may protrude in the upward direction. In addition, the hook protrusion 35a formed on the fitting protrusion 35 disposed at the lower end of the door button 30 may protrude in the downward direction.

Each of the hook protrusions 35a may be latched to a rear surface of the rear support plane 19 to restrict forward movement of the fitting protrusion 35. That is, the door button 30 may be provided to the control panel 15 to be movable in the front-rear direction through coupling between the fitting protrusions 35 and the rear support plane 19, and the hook protrusions 35a may be latched to the rear support plane 19 to restrict separation of the door button 30 from the control panel 15.

The cooking appliance according to this embodiment may further include a power transmission member 50. The power transmission member 50 may be disposed to be movable between a coupling position and an uncoupling position. At the coupling position, the power transmission member 50 may allow engagement between the latch mechanism 40 and the main body 10. At the uncoupling position, the power transmission member 50 may release engagement between the latch mechanism 40 and the main body 10.

The power transmission member 50 may be disposed behind the rear support plane 19. That is, the rear support plane 19 may be disposed between the pressing plane 31 and the power transmission member 50, more specifically between the pressing plane 31 and a transmission panel 55 described below.

In this embodiment, the power transmission member 50 includes a transmission shaft 51 and the transmission panel 55.

The transmission shaft 51 may be disposed to rotate about a lateral axis. The transmission shaft 51 may be connected to the latch mechanism 40 to change the position of the latch mechanism 40.

For example, the latch mechanism 40 engaging with the latch structure may be moved to a position in which the latch mechanism 40 is separated from the latch structure, by a rotational shaft 111 rotating in one direction. In addition, the latch mechanism 40 may be moved to a position in which the latch mechanism engages with the latch structure, by the rotational shaft 111 rotating in the other direction.

That is, when the power transmission member 50 is moved from the coupling position to the uncoupling position, the transmission shaft 51 may release engagement between the latch mechanism 40 and the main body 10 while rotating in one direction. In addition, when the power transmission member 50 is moved from the uncoupling position to the coupling position, the transmission shaft 51 may allow engagement between the latch mechanism 40 and the main body 10 while rotating in the other direction.

When pressed by user manipulation, the door button 30 moves to a pressed position to move the power transmission member 50 to the uncoupling position. To this end, the door button 30 may be provided with the pushing protrusion 37 and the power transmission member 50 may be provided with the transmission panel 55.

The pushing protrusion 37 may protrude backward from the pressing plane 31. The pushing protrusion 37 may connect with the transmission panel 55 through the rear support plane 19 disposed between the pressing plane 31 and the transmission panel 55.

By way of example, the length of the pushing protrusion 37 in the front-rear direction may be set corresponding to a distance between the pressing plane 31 and the transmission panel 55. When the door button 30 is moved to the pressed position, the pushing protrusion 37 may push the transmission panel 55 in a backward direction to move the power transmission member 50 to the coupling position.

The control panel 15 may further include a support boss 19a. The support boss 19a may protrude from the rear support plane 19 in the front-rear direction and may have a hollow space therein.

The pushing protrusion 37 may be movably coupled to the support boss 19a, specifically through a hollow space of the support boss 19a. That is, the pushing protrusion 37 may be movably coupled to the support boss 19a and passable through the rear support plane 19.

The support boss 19a may guide the forward-backward movement of the pushing protrusion 37 while stably guiding the pushing protrusion 37. The door button 30 may be provided with a plurality of pushing protrusions 37 and the control panel 15 may also be provided with a plurality of support bosses 19a corresponding thereto.

With this structure, the door button 30 may be stably installed to the control panel 15 and the movement of the door button 30 and the pushing protrusions 37 formed thereon may be stably guided.

In particular, when the pushing protrusions 37 push the transmission panel 55, the pushing protrusions 37 could be shaken in the lateral direction or in the up-down direction due to load applied to the pushing protrusions 37. The support bosses 19a serve to stably support the pushing protrusions 37 so as to suppress the shaking of the pushing protrusions 37.

The transmission panel 55 may be connected to the transmission shaft 51 and be disposed behind the pushing protrusions 37. The transmission panel 55 may be disposed to rotate about one side thereof connected to the transmission shaft 51 in the front-rear direction.

A front surface of the transmission panel 55 facing the pushing protrusion 37 may be a flat plane. In addition, the transmission panel 55 may include a support structure that protrudes backward from the front surface of the transmission panel 55. The transmission shaft 51 may be disposed behind the front surface of the transmission panel 55 and may be connected to the support structure protruding backward from the transmission panel 55.

The front surface of the transmission panel 55 formed as a flat plane may provide a contact surface on which the pushing protrusions 37 slides on the transmission panel 55 when the pushing protrusions 37 push the transmission panel 55 in the backward direction. In addition, the support structure protruding backward from the transmission panel 55 may further enhance the strength of the power transmission member 50.

In addition, the transmission shaft 51 is connected to the support structure protruding backward from the transmission panel 55, whereby a contact point between the transmission panel 55 and the pushing protrusions 37 may be placed farther forward than the transmission shaft 51.

Accordingly, the lengths of the pushing protrusions 37 may be further reduced, thereby reducing risks of shaking or damage to the pushing protrusions 37 while further improving structural stability of the door button 30 including the pushing protrusions 37.

On the other hand, a first resilient member 39 may be disposed between the pressing plane 31 of the door button 30 and the rear support plane 19 of the control panel 15 to resiliently support the door button 30. The first resilient member 39 may provide resilient force for returning the door button 30, which has moved to the pressed position, to an original position. The first resilient member 39 may be provided in the form of a coil spring which has a rear end supported by the rear support plane 19 and a front end supporting the pressing plane 31.

By way of example, the first resilient member 39 may be provided in plural such that each of the first resilient members 39 may be fitted onto an outer peripheral surface of the respective pushing protrusion 37 while surrounding the outer peripheral surface thereof. The pushing protrusion 37 fitted into the first resilient member 39 may stably support the first resilient member 39.

[Overall Structure of Locking Mechanism]

The locking mechanism 300 may be disposed to selectively restrict movement of the door button 30. The locking mechanism 300 may include a locking rod 110 and a manipulation member 120.

The locking rod 110 substantially restricts movement of the door button 30. The locking rod 110 may allow change of a posture thereof to a locking posture and an unlocking posture.

In the locking posture, the locking rod 110 may restrict movement of the door button 30 to the pressed position. In the unlocking posture, the locking rod 110 may allow movement of the door button 30 to the pressed position.

The locking rod 110 may be disposed inside the control panel 15. Most of the locking rod 110 may be disposed at a location deviating from the door button-insertion hole 15a. When the locking rod 110 is in the locking posture, a portion of the locking rod 110 may be positioned at the door button-insertion hole 15a. The portion of the locking rod 110 positioned at the door button-insertion hole 15a may be placed behind the door button 30 to restrict the movement of the door button 30.

That is, in the locking posture, at least a portion of the locking rod 110 is disposed on a movement path of the door button 30 to restrict the movement of the door button 30. Further, in the unlocking posture, the locking rod 110 deviates from the movement path of the door button 30 to allow the movement of the door button 30.

The locking rod 110 may include a rotational shaft 111, a locking protrusion 113, and a first connection protrusion 115.

The rotational shaft 111 may be disposed to rotate about a forward-backward axis. The locking protrusion 113 may be connected to the rotational shaft 111 to move in conjunction with the rotation of the rotational shaft 111. The first connection protrusion 115 may extend from the rotational shaft 111 so as to connect with the manipulation member 120.

By way of example, the first connection protrusion 115 may protrude from the rotational shaft 111 in a circumferential direction. The first connection protrusion 115 may rotate the rotational shaft 111 while moving in conjunction with the movement of the manipulation member 120.

[Structure of Manipulation Member and Periphery thereof]

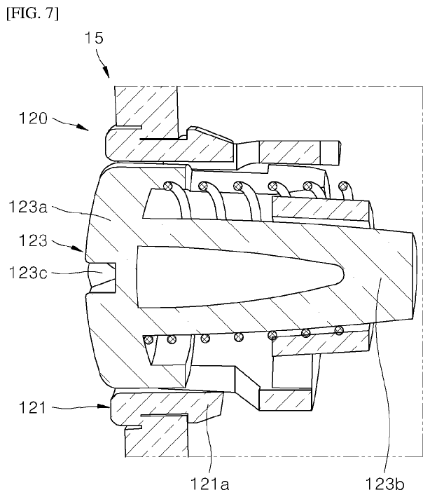

FIG. 7 is a cross-sectional view of the manipulation member of FIG. 6.

Referring to FIG. 4 to FIG. 7, the manipulation member 120 may be pressed by user manipulation. When pressed by user manipulation, the manipulation member 120 may change the posture of the locking rod 110 from the locking posture to the unlocking posture.

In this embodiment, the manipulation member 120 is disposed on a side surface of the control panel 15. In this structure, the manipulation member 120 may be disposed at the control panel 15 to move in the lateral direction. The manipulation member 120 may move in the lateral direction when pressed by user manipulation. For example, the manipulation member 120 disposed on a left side surface of the control panel 15 may move to the right when pressed by user manipulation.

The control panel 15 may be formed with a manipulation member-insertion hole 15b. The manipulation member-insertion hole 15b may be formed on a side surface of the control panel 15 to pass therethrough in the lateral direction. The manipulation member 120 may be inserted into the manipulation member-insertion hole 15b to be disposed on the side surface of the control panel 15.

The manipulation member 120 may include a button housing 121 and a manipulation button 123.

The button housing 121 may be inserted into the manipulation member-insertion hole 15b to be coupled to the side surface of the control panel 15. The manipulation member 120 may include a hook member 121a provided at the button housing 121.

The hook member 121a may be formed to have a protrusion protruding from the button housing 121 in the circumferential direction and may be resiliently deformable in a radial direction of the button housing 121. The hook member 121a may be disposed inside the control panel 15 to latch to an inner surface of the control panel 15. The button housing 121 may be fitted into the side surface of the control panel 15 through the hook member 121a.

The manipulation button 123 may be inserted into the button housing 121 to be movable in the button housing 121. The manipulation button 123 may include a pressing plane 123a and a fitting shaft 123b.

The pressing plane 123a may form a plane on which a user can press the manipulation button 123. The fitting shaft 123b may protrude from the pressing plane 123a in the lateral direction to be inserted into the button housing 121. The fitting shaft 123b may be provided at the button housing 121 to be movable in the button housing 121 in the lateral direction.

The manipulation button 123 may further include a manipulation groove 123c. The manipulation groove 123c may be formed in a concave groove shape on the pressing plane 123a. The manipulation groove 123c may serve to allow a tool, such as a screw driver and the like, which may be used to rotate the manipulation button 123, to engage with the manipulation button 123.

The manipulation member 120 may be provided with a second resilient member 125 which resiliently supports the manipulation button 123. The second resilient member 125 may provide resilient force for returning the manipulation button 123, which has been pressed by user manipulation, to an original position. The second resilient member 125 may be provided in the form of a coil spring which has one end supported by the button housing 121 and the other end supporting the manipulation button 123 in the lateral direction.

The manipulation button 123 may be disposed at one side of the door button 30. That is, when a user presses the manipulation button 123, which is disposed at one side of the control panel 15 placed near the door button 30, in the lateral direction, the locking mechanism 300 may be changed to an unlocked state.

The posture of the locking rod 110 may be changed by cooperation between the manipulation button 123 and the first connection protrusion 115. When pressed by user manipulation, the manipulation member 120 may move in the lateral direction and the first connection protrusion 115 may move in a rotational direction of the rotational shaft 111 in conjunction with lateral movement of the manipulation member 120.

According to this embodiment, the manipulation button 123 may connect with the first connection protrusion 115 so as to adjoin therewith in the lateral direction. When the manipulation button 123 connected with the first connection protrusion 115 is pressed by user manipulation, the manipulation button 123 may move towards the other side in the lateral direction.

With the manipulation button 123 adjoining the connection protrusion 115 in the lateral direction, the manipulation button 123 may press the first connection protrusion 115 in the rotational direction of the rotational shaft 111 while moving in the lateral direction. As a result, the rotational shaft 111 may be rotated and the locking protrusion 113 may be moved to the locking position in conjunction with rotation of the rotational shaft 111.

[Structure of Locking Protrusion and Periphery thereof]

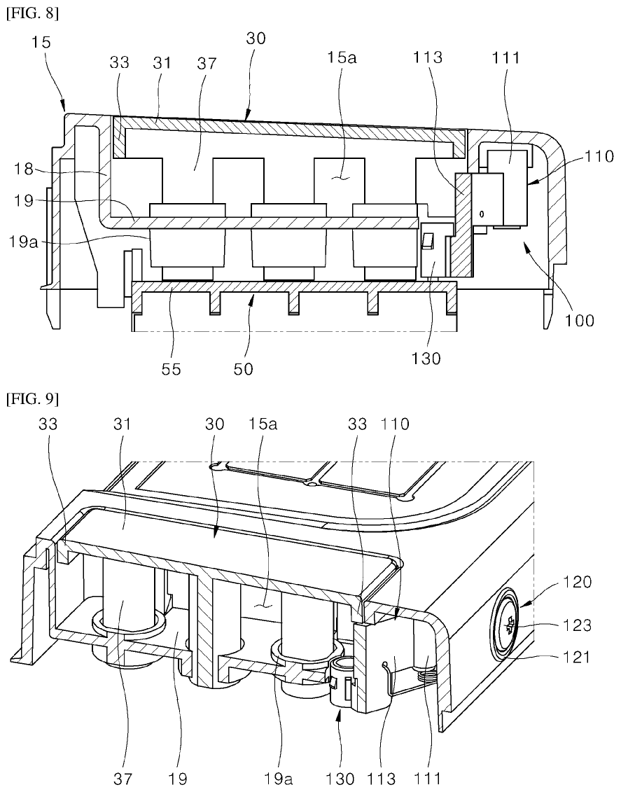

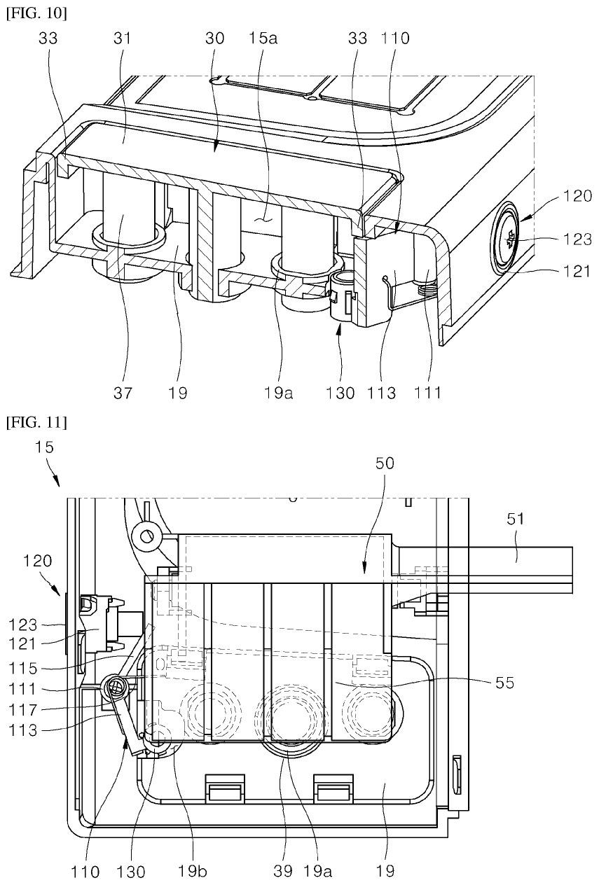

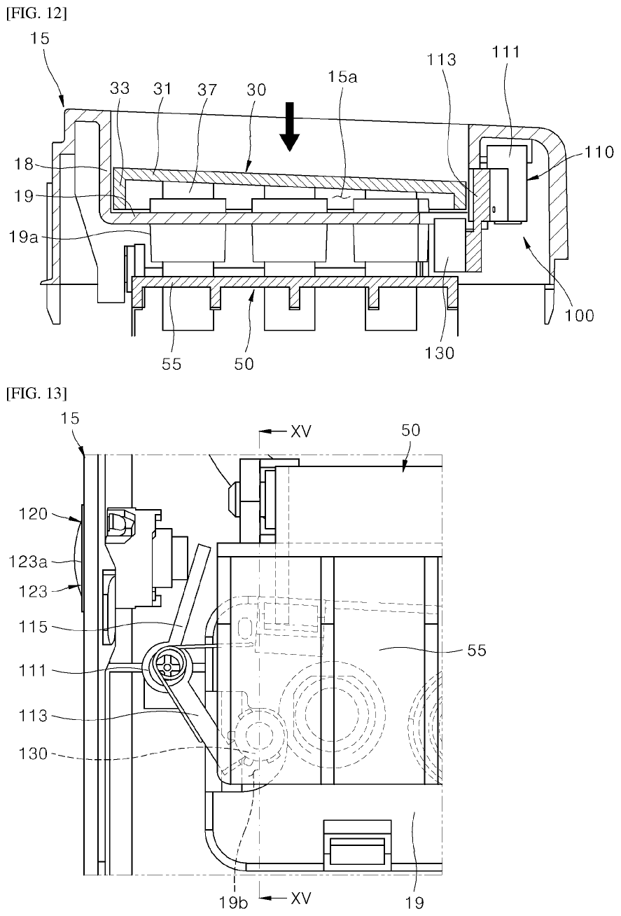

FIG. 8 is a cross-sectional view of a locking mechanism according to the first embodiment of the present disclosure, FIG. 9 is a sectional perspective view of the locking mechanism according to the first embodiment of the present disclosure, which is taken along line IX-IX of FIG. 6, and FIG. 10 is a partially enlarged view of the door button and the locking mechanism shown in FIG. 9. In addition, FIG. 11 is a rear view illustrating an unlocking state of the locking mechanism shown in FIG. 6 and FIG. 12 is a cross-sectional view of the locking mechanism shown in FIG. 10.

Referring to FIG. 6 to FIG. 10, the locking rod 110 may include the rotational shaft 111 connected to the first connection protrusion 115 and the locking protrusion 113 connected to the rotational shaft 111.

The rotational shaft 111 may be disposed to rotate about the forward-backward axis. The rotational shaft 111 may be rotated by the first connection protrusion 115 which is moved by the manipulation member 120.

By way of example, the rotational shaft 111 may have a cylindrical shape extending in the front-rear direction. The rotational shaft 111 may be rotatably coupled to the front surface of the control panel 15. In addition, the rotational shaft 111 may be disposed at a location deviated from the door button-insertion hole 15a.

The first connection protrusion 115 connected to the rotational shaft 111 may be disposed at a position deviated from the door button-insertion hole 15a. At the unlocking position, the locking protrusion 113 connected to the rotational shaft 111 may be disposed at a position deviated from the door button-insertion hole 15a.

The locking protrusion 113 may be connected to the rotational shaft 111 to move in conjunction with rotation of the rotational shaft 111. In this embodiment, the locking protrusion 113 protrudes from the rotational shaft 111 in the circumferential direction.

According to this embodiment, the rotational shaft 111 may be disposed at a location deviated from the door button-insertion hole 15a. When placed at the locking position, the locking protrusion 113 connected to the rotational shaft 111 may protrude into the door button-insertion hole 15a through the inner surface 18 of the control panel 15.

To this end, the inner surface 18 of the control panel 15 may be provided with a first through-hole 18a. The first through-hole 18a may be disposed between the manipulation member 120 and the door button-insertion hole 15a and may be formed on the inner surface 18 of the control panel 15 to pass therethrough in the lateral direction.

When the locking rod 110 is placed at the locking position, the locking rod 110, more specifically at least a portion of the locking protrusion 113, may protrude into a region between the rear support plane 19 and the edge protrusion 33 through the first through-hole 18a.

According to this embodiment, the locking protrusion 113 may be moved to the locking position and the unlocking position in conjunction with the rotation of the rotational shaft 111. When placed at the locking position, the locking protrusion 113 may restrict movement of the door button 30 from behind the door button 30. Further, at the unlocking position, the locking protrusion 113 may allow movement of the door button 30.

By way of example, the locking protrusion 113 may restrict movement of the door button 30 through interference of the door button 30 with the edge protrusion 33. In this example, when the locking rod 110 has the unlocking posture, the locking mechanism 300 may be placed outside the door button 30 in the lateral direction.

Referring to FIG. 10 to FIG. 12, in the unlocking posture, the locking rod 110 may be disposed at a position deviated from the door button-insertion hole 15a. The entirety of the locking mechanism 300 including the locking rod 110 may be disposed at a location deviated from the door button-insertion hole 15a, that is, outside the door button 30 in the lateral direction.

Further, when the locking rod 110 has the locking posture, at least a portion of the locking rod 110 may be disposed at a movement path of the edge protrusion 33, as shown in FIG. 6 to FIG. 9. Here, at least a portion of the locking rod 110, that is, at least a portion of the locking protrusion 113, is disposed behind the door button 30 to be placed on the movement path of the edge protrusion 33.

As such, the locking protrusion 113 disposed on the movement path of the edge protrusion 33 may restrict movement of the door button 30 from behind the edge protrusion 33 through interference with the edge protrusion 33.

When the locking rod 110 has the locking posture, movement of the door button 30 is restricted by the locking mechanism 300 to prevent the door button 30 from moving to the pressed position, thereby preventing the door 20 from being opened.

The locking mechanism 300 may further include a third resilient member 117 which resiliently supports the locking rod 110. The third resilient member 117 may provide resilient force for returning the posture of the locking rod 110, which has changed to the unlocking posture, to the locking posture. In this embodiment, the third resilient member 117 includes a torsion spring which has one end supported by the button housing 121 and the other end supporting the locking rod 110.

By way of example, the third resilient member 117 may be coupled at one end thereof to the rear support plane 19 and at the other end thereof to the locking protrusion 113. With this structure, the third resilient member 117 may provide resilient force for returning the locking protrusion 113, which has moved to a first unlocking position, to a first locking position.

The third resilient member 117 may return the posture of the locking rod 110 to the locking posture while moving the rotational shaft 111 and the first connection protrusion 115 together by moving the locking protrusion 113, as described above.

[Structure of Locking Rod-Securing Member and Periphery thereof]

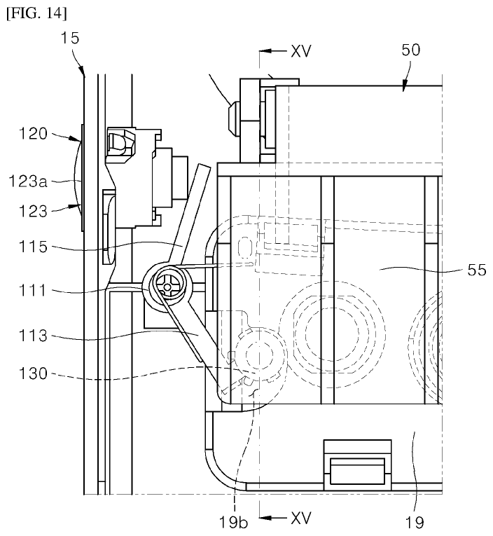

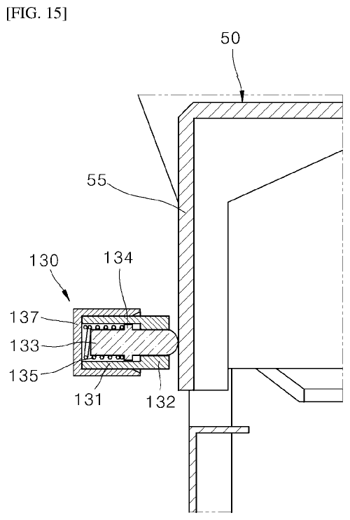

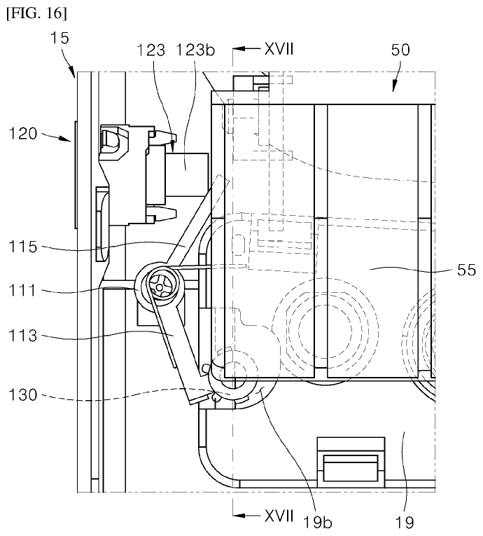

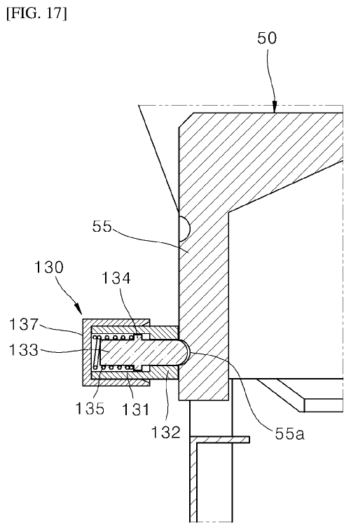

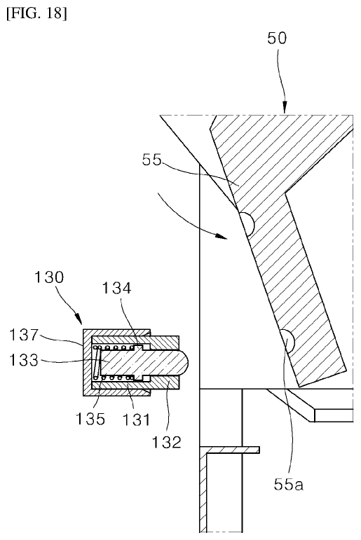

FIG. 13 is a rear view illustrating the transmission panel and a locking rod-securing member when the locking rod is placed at the locking position, FIG. 14 is a front view of the transmission panel excluding the locking rod-securing member shown in FIG. 13, and FIG. 15 is a cross-sectional view taken along line XV-XV of FIG. 13. FIG. 16 is a front view illustrating the transmission panel and the locking rod-securing member when the locking rod is placed at the unlocking position, FIG. 17 is a cross-sectional view taken along line XVII-XVII of FIG. 16, and FIG. 18 is a cross-sectional view of the power transmission panel of FIG. 17 moved to an uncoupling position.

Referring to FIG. 13 to FIG. 15, the locking rod 110 may further include a locking rod-securing member 130. The locking rod-securing member 130 may be disposed to move in conjunction with movement of the locking protrusion 113. The locking rod-securing member 130 may be coupled to the transmission panel 55 to secure the locking rod 110 to the transmission panel 55 when the locking protrusion 113 is placed at the unlocking position.

In this embodiment, the locking rod-securing member 130 protrudes backward from the locking protrusion 113. When the locking protrusion 113 is placed at the unlocking position, the locking rod-securing member 130 may serve to maintain the unlocking posture of the locking rod 110 instead of allowing the locking rod 110 to return to the locking posture by securing the locking rod 110 to the transmission panel 55.

The locking rod-securing member 130 may protrude backward from the locking protrusion 113 and may be connected to the power transmission member 50 through the rear support plane 19. To this end, the rear support plane 19 may be provided with a second through-hole 19b. The second through-hole 19b may be formed through the rear support plane 19 in the front-rear direction.

The locking rod-securing member 130 may be connected to the power transmission member 50, more specifically to the transmission panel 55 through the second through-hole 19b of the rear support plane 19.

According to this embodiment, the locking rod-securing member 130 may include a protruding boss 131, 132, a securing protrusion 133, 134, and a fourth resilient member 135.

The protruding boss 131, 132 may be connected to the locking protrusion 113. The protruding boss 131, 132 may protrude backward from the locking protrusion 113. In this embodiment, the protruding boss 131, 132 is formed in a cylindrical shape protruding from the locking protrusion to have a hollow space therein. The protruding boss 131, 132 may receive and support the securing protrusion 133, 134 and the fourth resilient member 135.

The securing protrusion 133, 134 may be movably coupled to the protruding boss 131, 132. The securing protrusion 133, 134 may be inserted into the protruding boss 131, 132 to be movable therein in the front-rear direction. Most of the securing protrusion 133, 134 may be received in the protruding boss 131, 132 and a rear portion of the securing protrusion 133, 134 may protrude backward from the protruding boss 131, 132 through the protruding boss 131, 132.

The securing protrusion 133, 134 may include a protrusion portion 133 and a flange portion 134. The protrusion portion 133 may be formed in a circular bar shape extending in the front-rear direction. Most of the protrusion portion 133 may be received in the protruding boss 131, 132 and a rear portion of the protrusion portion 133 may protrude backward from the protruding boss 131, 132 through the protruding boss 131, 132. A rear end of the protrusion portion 133 may have a round shape.

The flange portion 134 may protrude from the protrusion portion 133 in the circumferential direction. The flange portion 134 may be received in the protruding boss 131, 132 and may be moved together with the protrusion portion 133 in the front-rear direction.

The protruding boss 131, 132 may be divided into a front section 131 and a rear section 132. The front section 131 and the rear section 132 may be arranged in the front-rear direction and the front section 131 may have a larger inner diameter than the rear section 132.

For example, the inner diameter of the front section 131 may be set to a size greater than or equal to an outer diameter of the flange portion 134. In addition, the inner diameter of the rear section 132 may be set to a size between an outer diameter of the protrusion portion 133 and the outer diameter of the flange portion 134. In addition, a step may be formed at a border between the front section 131 and the rear section 132.

The flange portion 134 may be received in the front section 131 to move therein in the front-rear direction. A portion of the protrusion portion 133 behind the flange portion 134 may be moved in the rear section 132 in the front-rear direction.

Accordingly, backward movement of the securing protrusion 133, 134 may be restricted to a location at which interference between the flange portion 134 and the step occurs. Such interference between the flange portion 134 and the step may provide an effect of preventing separation of the securing protrusion 133, 134 through the protruding boss 131, 132.

The locking rod-securing member 130 may further include a boss cap 137. The boss cap 137 may be coupled to the protruding boss 131, 132 while covering an open front side of the protruding boss 131, 132.

The fourth resilient member 135 may provide resilient force that forces the securing protrusion 133, 134 to move towards the transmission panel 55, that is, in the backward direction. The fourth resilient member 135 may be provided in the form of a coil spring which has a front end supported by the boss cap 137 and a rear end supported by the flange portion 134.

According to this embodiment, the securing protrusion 133, 134 may be coupled to the transmission panel 55, whereby the locking rod-securing member 130 can be coupled to the transmission panel 55.

To this end, the transmission panel 55 may be provided with a securing groove 55a and the securing protrusion 133, 134 may be inserted into the securing groove 55a to be coupled to the transmission panel 55.

The securing groove 55a may be formed on a front surface of the transmission panel 55 facing the securing protrusion 133, 134. The securing groove 55a may be concavely formed backward on the front surface of the transmission panel 55.

In this embodiment, a rear end of the securing protrusion 133, 134 may be of semispherical shape. In addition, the securing groove 55a may be formed in a concave shape on the transmission panel 55 to have a semispherical shape corresponding to the shape of the rear end of the securing protrusion 133, 134.

When the locking rod 110 has the locking posture, that is, when the locking protrusion 113 is placed at the locking position, the securing protrusion 133, 134 may be maintained in a contact state with the transmission panel 55 outside the securing groove 55a.

Here, the securing protrusion 133, 134 may contact the transmission panel 55 in a state of being withdrawn forward instead of being placed to protrude backward as much as possible. The securing protrusion 133, 134 may be maintained in a close contact state with the transmission panel 55 by resilient force provided by the fourth resilient member 135.

Referring to FIG. 16 and FIG. 17, when the locking rod 110 has the unlocking posture, that is, when the locking protrusion 113 is placed at the unlocking position, the securing protrusion 133, 134 may move toward the securing groove 55a along with the locking protrusion 113. The securing protrusion 133, 134 may be inserted into the securing groove 55a to be coupled to the transmission panel 55.

The securing protrusion 133, 134 may be pushed backward and inserted into the securing groove 55a by resilient force provided by the fourth resilient member 135. When inserted into the securing groove 55a, the securing protrusion 133, 134 may be brought into close contact with the transmission panel 55 to be coupled to the transmission panel 55. By the securing protrusion 133, 134 coupled to the transmission panel 55, the locking rod-securing member 130 may be coupled to the transmission panel 55.

As such, when the locking rod-securing member 130 is coupled to the transmission panel 55, the locking protrusion 113 moved to the unlocking position may be maintained in the unlocking position. As a result, even when a force forces the locking protrusion 113 to move from the unlocking position, the locking protrusion 113 does not move to the locking position so long as coupling between the locking rod-securing member 130 and the transmission panel 55 is maintained.

Coupling between the locking rod-securing member 130 and the transmission panel 55 may be maintained even when the force forces the locking protrusion 113 to move from the unlocking position. Accordingly, once the posture of the locking rod 110 is changed from the locking posture to the unlocking posture, the posture of the locking rod 110 may be maintained in the unlocking posture so long as additional manipulation of the locking mechanism 300 is not carried out.

In the state wherein the posture of the locking rod 110 is maintained in the unlocking posture as described above, pressing manipulation with respect to the door button 30 is allowed. In this state, the door button 30 may be moved to the pressed position by pressing manipulation.

When the door button 30 is moved to the pressed position, the transmission panel 55 may move backward while being pushed by the pushing protrusion 37, as shown in FIG. 18. When the transmission panel 55 is moved backward, engagement between the latch mechanism and the main body is released simultaneously with coupling between the locking rod-securing member 130 and the transmission panel 55.

As a result, the door can be opened and the locking protrusion 113 returns from the unlocking position to the locking position, whereby the posture of the locking rod 110 may be returned from the unlocking posture to the locking posture.

[Operation and Effect of Locking Mechanism]

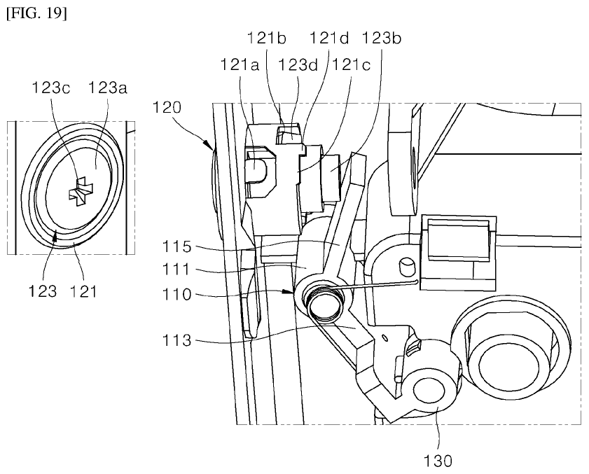

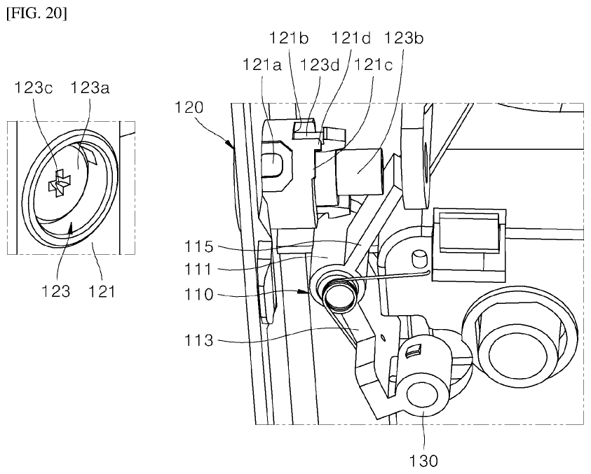

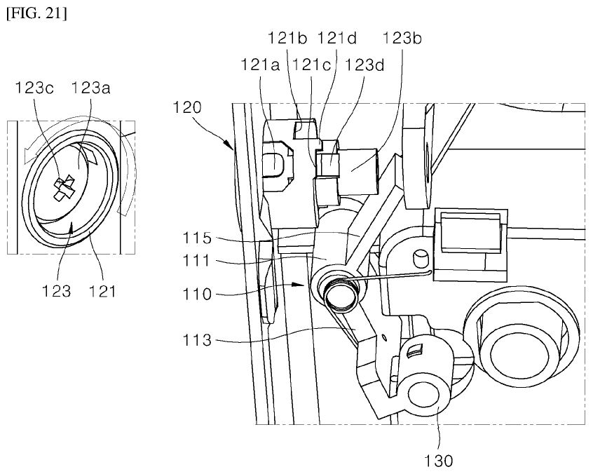

FIG. 19 is a rear perspective view illustrating a locking state of the locking mechanism according to the first embodiment of the present disclosure, FIG. 20 is a rear perspective view illustrating an unlocking state of the locking mechanism shown in FIG. 19, and FIG. 21 is a rear perspective view illustrating a function-release state of the locking mechanism shown in FIG. 20.

Hereinafter, operation and effects of the cooking appliance according to the first embodiment will be described with reference to FIG. 6 to FIG. 21.

Referring to FIG. 1 to FIG. 9, while the door 20 closes the cooking chamber 14, the door 20 may be secured to the main body 10 by the latch mechanism 40 (see FIG. 2). In addition, the door button 30 may be locked by the locking mechanism 300 so as not to be moved to the pressed position by the pressing manipulation.

In other words, while the door 20 closes the cooking chamber 14, the door 20 may be secured to the main body 10 by the latch mechanism 40 and the door button 30 for opening the door 20 may be locked by the locking mechanism 300.

That is, in the cooking appliance according to this embodiment, opening of the door 20 may be dually restricted by the latch mechanism 40 and the locking mechanism 300.

While opening of the door 20 is dually restricted by the latch mechanism 40 and the locking mechanism 300, at first, it is necessary to release a locked state of the door button 30 by the locking mechanism 300.

That is, in order to allow the door 20 to open the cooking chamber 14, the posture of the locking mechanism 300 placed behind the door button 30 and restricting movement of the door button 30 should be changed from the locking posture to the unlocking posture, as shown in FIG. 10.

To this end, as shown in FIG. 11, a user may press the manipulation member 120 to move the manipulation member 120 in the lateral direction. Accordingly, the first connection protrusion 115 connecting with the manipulation member 120 may rotate the rotational shaft 111 while moving in the rotational direction of the rotational shaft 111.

As a result, the locking protrusion 113 is moved from the locking position to the unlocking position in conjunction with rotation of the rotational shaft 111, whereby the locking rod 110 may deviate from a movement path of the door button 30.

When the posture of the locking rod 110 is changed to the unlocking posture in this way, an obstacle placed behind the door button 30 and restricting movement of the door button 30 is removed from the movement path of the door button 30. As a result, the door button 30 may move toward the pressed position through pressing manipulation with respect to the door button 30.

When the posture of the locking rod 110 is changed to the unlocking posture as described above, the securing protrusion 133, 134 is inserted into the securing groove 55a to be coupled to the transmission panel 55, as shown in FIG. 16 and FIG. 17, whereby the locking rod-securing member 130 may be coupled to the transmission panel 55.

As such, the locking rod-securing member 130 coupled to the transmission panel 55 may maintain the posture of the locking rod 110 in the unlocking posture. Accordingly, when a user presses the manipulation member 120 to change the posture of the locking rod 110 to the unlocking posture, the unlocking posture of the locking rod 110 may be maintained even when the user does not continue to press the manipulation member 120.

That is, since the user can open the door by pressing the door button 30 again with the hand that has pressed the manipulationmember 120, it is possible to open the door easily and conveniently with only one hand instead of using both hands together.

When the door is opened through the pressing manipulation with respect to the door button 30, engagement between the latch mechanism and the main body is released simultaneously with the coupling between the locking rod-securing member 130 and the transmission panel 55.

Thereafter, when the force pressing the door button 30 is removed, the door button 30 moves forward and return to the original position while the locking protrusion 113 returns from the unlocking position to the locking position.

As such, opening of the door may be achieved together with posture returning of the locking rod 110 by pressing manipulation with respect to the door button 30, whereby locking of the door button 30 may be automatically achieved even without additional manipulation, when the door 20 is closed again.

When the locking rod 110 automatically returns to a securing position such that the door 20 is rotated backward again to close the cooking chamber 14, the door 20 may be locked again by the locking mechanism 300 even without separate manipulation with respect to the locking mechanism 300.

That is, in the cooking appliance according to this embodiment, the door button 30 may be released from the locked state by the locking mechanism 300 through the pressing manipulation with respect to the manipulation member 120 and the door button 30 may be locked again by the locking mechanism 300 even without separate manipulation.

The door button 30 may be released from the locked state by the locking mechanism 300 by pulling the locking mechanism 300 in the lateral direction and the door button 30 may be locked again by the locking mechanism 300 even without separate manipulation after opening or closing of the door 20 (see FIG. 2).

Accordingly, the cooking appliance according to this embodiment allows for easy and convenient restriction of the door 20 to prevent unintentional opening of the cooking chamber 14 (see FIG. 2) while allowing automatic and safe locking of the door button 30 even without separate manipulation.

For the cooking appliance according to this embodiment as described above, restriction of the door button 30 is first released in order to allow manipulation for opening the door 20, thereby effectively preventing unintentional opening of the cooking chamber 14 during operation of the cooking appliance.

In addition, the cooking appliance according to this embodiment allows the locking rod 110 to automatically return to the original posture, in which the locking rod 110 locks the door button 30, even without separate manipulation, thereby improving both stability of the cooking appliance and convenience in manipulation thereof.

Further, the cooking appliance according to this embodiment suppresses frequent unnecessary opening/closing of the door, thereby effectively suppressing unstable opening/closing operation of the door due to the latch mechanism being worn out prematurely.

As shown in FIG. 19, the button housing 121 may be provided with a latch groove 121b. The latch groove 121b may be formed in a concave shape on the other end of the button housing 121 in the lateral direction.

Further, the manipulation button 123 may further include a latch protrusion 123d. The latch protrusion 123d may protrude from the fitting shaft 123b in the circumferential direction.

The fitting shaft 123b may be movably inserted into a hollow space of the button housing 121 and the latch protrusion 123d may be inserted into the latch groove 121b. The latch protrusion 123d may be moved along the fitting shaft 123b in a straight direction.

When the fitting shaft 123b moves inside the button housing 121, the latch protrusion 123d may move into the latch groove 121b. The latch protrusion 123d may be moved to one of an insertion position in which the latch protrusion 123d is inserted into the latch groove 121b and a separation position in which the latch protrusion 123d is separated from the latch groove 121b.

As such, the manipulation button 123 may move in the lateral direction and may also rotate about the lateral axis. Here, the manipulation button 123 may rotate about a radial center of the fitting shaft 123b.

The posture of the manipulation member 120 including the manipulation button 123 may be changed to one of a posture allowing movement of the manipulation button 123 in the straight direction and a posture restricting movement of the manipulation button 123 in the straight direction.

To this end, the button housing 121 may be formed with a latch step 121c. The latch step 121c may be disposed at one end of the button housing 121 in the lateral direction, specifically at one side of the button housing 121 facing the pressing plane 123a of the manipulation button 123 in the lateral direction.

The latch step 121c may form one end of the button housing 121 in the lateral direction. The latch step 121c may serve to block movement of the latch protrusion 123d from the separation position to the insertion position. That is, the latch step 121c may act as a blocking wall that blocks movement of the latch protrusion 123d separated from the latch groove 121b towards the other side in the lateral direction.

Furthermore, the button housing 121 may be further formed with a rotation-suppressing protrusion 121d. The rotation-suppressing protrusion 121d may be disposed between the latch groove 121b and the latch step 121c.

The rotation-suppressing protrusion 121d may be provided in the form of a protrusion protruding from the other end of the button housing 121 beyond the latch step 121c in the lateral direction. The rotation-suppressing protrusion 121d serves to obstruct the latch protrusion 123c, which is separated from the latch groove 121b and latched to the latch step 121c, from being inserted again into the latch groove 121b.

That is, the rotation-suppressing protrusion 121d may serve to block change of the locking mechanism 300 from a function-release state to the locking state due to unintentional rotation of the manipulation button 123.

When the locking mechanism 300 is maintained in the function-release state, that is, while the latch protrusion 123b is latched to the latch step 121c, the latch protrusion 123b may be prevented from being inserted again into the latch groove 121b due to the rotation-suppressing protrusion 121d even upon rotation of the manipulation button 123.

In order to change the locking mechanism 300 from the function-release state to the locking state, it is necessary to perform pressing manipulation and rotation of the manipulation button 123 at the same time.

That is, in order to allow the latch protrusion 123b to be inserted into the latch groove 121b, the manipulation button 123 should be rotated in a state of being pressed so as to allow the latch protrusion 123b to move over the rotation-suppressing protrusion 121d.

Further, in order to allow the locking mechanism 300 to be changed to the locking state again while allowing the manipulation button 123 to return to the original position, the latch protrusion 123b should be inserted into the latch groove 121b.

As shown in FIG. 19, when the manipulation button 123 is pressed, the fitting shaft 123b may be moved to the other side in the lateral direction and the latch protrusion 123d may be moved to the separation position at which the latch protrusion 123d is separated from the latch groove 121b. In addition, when the force pressing the manipulation button 123 is released and the door button 30 is pressed, the manipulation button 123 may return to the original position as described above.

In a state of being pressed as described above, the manipulation button 123 may be rotated, as shown in FIG. 20. Here, the manipulation button 123 may be rotated by a tool, such as a screw driver and the like, and the manipulation groove 123c may serve to allow the coupling between the tool and the manipulation button 123.

The latch protrusion 123d may be completely separated from the latch groove 121b by rotation of the manipulation button 123. Here, the latch protrusion 123d may be placed on the outside the latch groove 121b with respect to the lateral direction as well as on the outside of the latch groove 121b with respect to the rotation direction.

In this way, the latch protrusion 123d separated from the latch groove 121b may interfere with the other end of the button housing 121 in the lateral direction. Due to interference between the latch protrusion 123b and the button housing 121, the manipulation button 123 is maintained in a pressed state generated by the pressing manipulation.

When the manipulation button 123 is maintained in the pressed state, the locking rod 110 may maintain the unlocking posture and the locking mechanism 300 may be maintained in the function-release state in which locking of the door 20 is released.

That is, the locking mechanism 300 according to this embodiment may provide a dual door-securing function to achieve stable securing of the door 20 and may maintain the function-release state when such a dual door-securing function is not required.

Accordingly, the cooking appliance according to this embodiment may provide a function of allowing the user to select whether to use the dual door-securing function according to the user's need by allowing the dual door-securing function to be released in a place where the dual door-securing function is unnecessary, such as a house without children.

[Second Embodiment of Locking Mechanism]

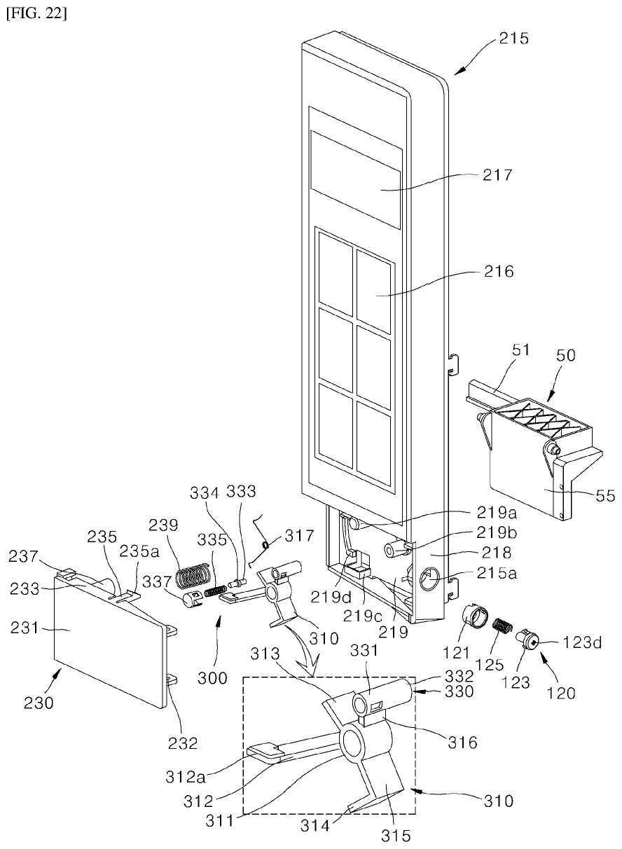

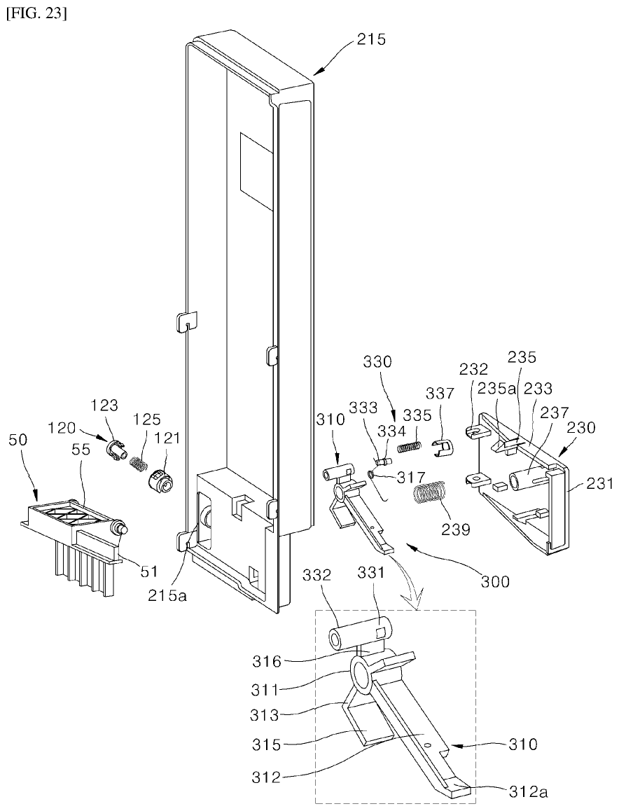

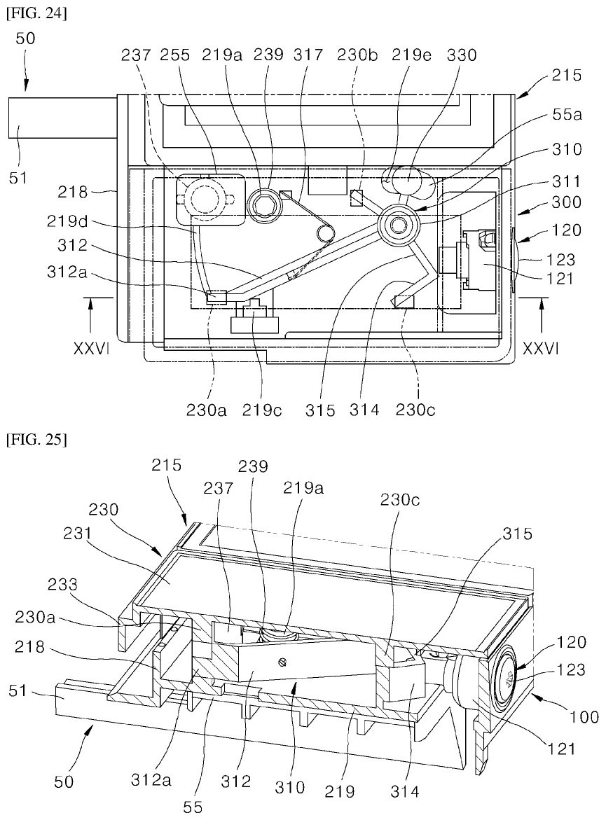

FIG. 22 is an exploded front perspective view of a control panel and a locking mechanism according to a second embodiment of the present disclosure, FIG. 23 is an exploded rear perspective view of the control panel and the locking mechanism according to the second embodiment of the present disclosure, and FIG. 24 is an enlarged front view of a door button according to the second embodiment of the present disclosure.

Referring to FIG. 22 to FIG. 24, a door button 230 may be provided at the control panel 215 and may be pressed by user manipulation. When pressed by user manipulation, the door button 230 moves to a pressed position to allow the latch mechanism 40 to be separated from the main body 10, more specifically from the latch structure of the main body 10.

In this embodiment, the door button 230 is rotatably coupled at one lateral side thereof to the control panel 215. With this structure, the door button 230 may be rotated about the one lateral side thereof to move to the pressed position.

By way of example, the door button 230 may include a pressing plane 231 and an edge protrusion 233. The pressing plane 231 corresponds to a front surface of the door button 230 capable of being pressed by user manipulation. The pressing plane 231 may form a flat plane parallel to the front surface of the control panel 215. The edge protrusion 233 may extend backward from a lateral edge of the pressing plane 231.

The door button 230 may further include a hinge 232. The hinge 232 may be biased to one of one side and the other side of the door button 230 in the lateral direction. The hinge 232 may be coupled to the control panel 215 to be rotatable about an upward-downward axis.

The door button 230 may be rotated about one side provided with the hinge 232 in the front-rear direction by the coupling between the hinge 232 and the control panel 215.

The control panel 215 may include a front surface forming a front external appearance of the control panel 215 and side surfaces extending backward from front edges of the control panel 215. The front surface of the control panel 215 may form a plane parallel to the door 20. The front surface of the control panel 215 may be provided with an input unit 216 and a display 217.

The control panel 215 may further include a rear support plane 219. The rear support plane 219 may be disposed under the control panel 215 and may form a plane under the control panel 215 to be disposed behind the front surface of the control panel 215.

The locking mechanism 300 may be disposed between the pressing plane 231 of the door button 230 and the rear support plane 219 to be supported by the rear support plane 219.

The control panel 215 may include a sidewall 218. The sidewall 218 of the control panel 215 may be formed as a wall that surrounds the periphery of the rear support plane 219. The sidewall 218 may be formed as a wall that protrudes forward from the periphery of the rear support plane 219.

The edge protrusion 233 of the door button 230 may form a plane parallel to the sidewall 218 of the control panel 215 and may extend backward from the pressing plane 231. The edge protrusion 233 of the door button 230 may be slidably coupled to the sidewall 218 of the control panel 215 in the front-rear direction.

A fitting protrusion may protrude backward from the pressing plane 231. The door button 230 may be formed with a plurality of fitting protrusions 235. For example, the door button 230 may be provided at upper and lower ends thereof with the fitting protrusions 235.

Each of the fitting protrusions 235 may pass through the rear support plane 219 and may be coupled to the rear support plane 219 to be movable in the front-rear direction. By the coupling between the fitting protrusions 235 and the rear support plane 219, the door button 230 may be coupled to the control panel 215 to be movable in the front-rear direction.

Each of the fitting protrusions 235 may be provided at a rear end thereof with a hook protrusion 235a. The hook protrusion 235a may protrude from the rear end of the fitting protrusion 235 in the up-down direction or in the lateral direction. For example, the hook protrusion 235a formed on the fitting protrusion 235 disposed at the upper end of the door button 230 may protrude in the upward direction. In addition, the hook protrusion 235a formed on the fitting protrusion 235 disposed at the lower end of the door button 230 may protrude in the downward direction.

Each of the hook protrusions 235a may be latched to a rear surface of the rear support plane 219 to restrict forward movement of the fitting protrusion 235. That is, the door button 230 may be provided at the control panel 215 to be movable in the front-rear direction through the coupling between the fitting protrusions 235 and the rear support plane 219, and the hook protrusions 235a may be latched to the rear support plane 219 to restrict separation of the door button 230 from the control panel 215.

When pressed by user manipulation, the door button 230 moves to the pressed position to force the power transmission member 50 to move to an uncoupling position. To this end, the door button 230 may be provided with a pushing protrusion 237 and the power transmission member 50 may be provided with a transmission panel 55.

On the other hand, a first resilient member 239 may be disposed between the pressing plane 231 of the door button 230 and the rear support plane 219 of the control panel 215 to resiliently support the door button 230. The first resilient member 239 may provide resilient force for returning the door button 230, which has moved to the pressed position, to the original position. The first resilient member 239 may be provided in the form of a coil spring which has a rear end supported by the rear support plane 219 and a front end supported by the pressing plane 231.

By way of example, the rear support plane 219 may be provided with a support protrusion 219a. The support protrusion 219a may protrude from the rear support plane 219 and may be secured to the rear support plane 219 in which the coil spring is fitted into the support protrusion 219a.

That is, the support protrusion 219a supports the first resilient member 239 and is secured to the rear support plane 219, whereby the first resilient member 239 may be stably secured to the control panel 215 while stably supporting the door button 230.

The door button 230 may include a plurality of backward protrusions 230a, 230b, 230c. In this embodiment, the door button 230 is provided with a first backward protrusion 230a, a second backward protrusion 230b, and a third backward protrusion 230c.

The first backward protrusion 230a, the second backward protrusion 230b and the third backward protrusion 230c may protrude backward from the pressing plane 231. The first backward protrusion 230a, the second backward protrusion 230b and the third backward protrusion 230c may be moved backward together with the door button 230 when the door button 230 is moved to the pressed position.

The locking mechanism 300 may be disposed to selectively restrict movement of the door button 230. The locking mechanism 300 may include a locking rod 310 and a manipulation member 120.

The locking rod 310 may restrict movement of the door button 230. The locking rod 310 may allow change of a posture thereof to a locking posture and an unlocking posture.

In the locking posture, the locking rod 310 may restrict movement of the door button 230 to the pressed position. In the unlocking posture, the locking rod 310 may allow movement of the door button 230 to the pressed position.

The locking rod 310 may be disposed inside the control panel 215. Most of the locking rod 310 may be disposed in a region covered by the door button 230. The locking rod 310 may be disposed behind the door button 230 to rotate about the forward-backward axis. The posture of the locking rod 310 may be changed to the locking posture and the unlocking posture by the rotation of the locking rod 310.

The locking rod 310 may include a rotational shaft 311, latch protrusions 312, 313, 314, and a first connection protrusion 315.

The rotational shaft 311 may be disposed to rotate about the forward-backward axis. The latch protrusions 312, 313, 314 may be connected to the rotational shaft 311 to move in conjunction with the rotation of the rotational shaft 311. The first connection protrusion 315 may extend from the rotational shaft 311 to connect with the manipulation button 123.

By way of example, the first connection protrusion 315 may protrude from the rotational shaft 311 in the circumferential direction. The first connection protrusion 315 may rotate the rotational shaft 311 while moving in conjunction with the movement of the manipulation button 123.

FIG. 25 is a cross-sectional perspective view taken along line XXVI-XXVI of FIG.

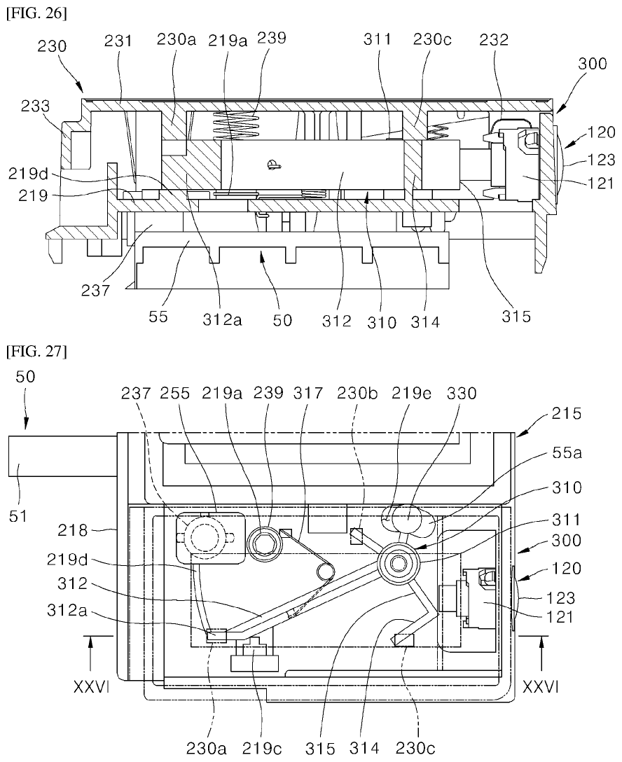

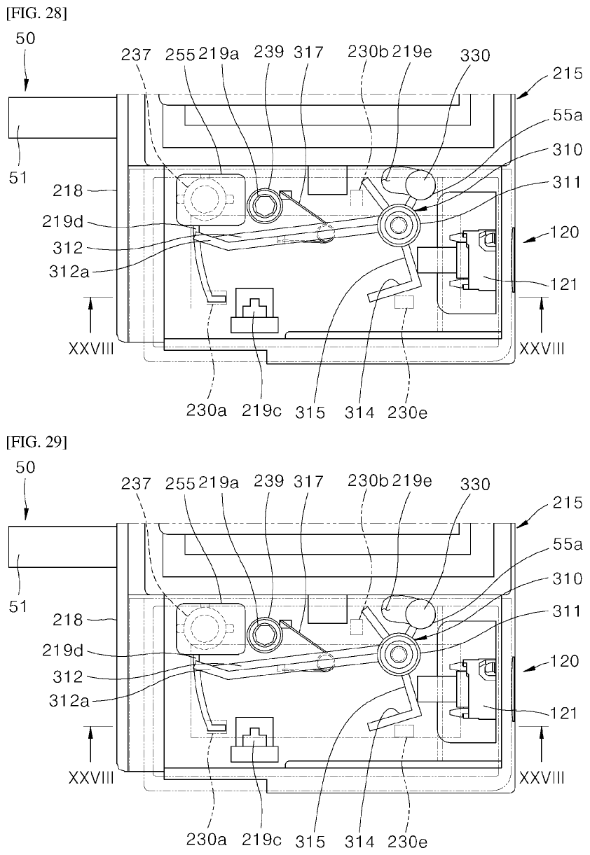

24 and FIG. 26 is a cross-sectional view taken along line XXVI-XXVI of FIG. 24. FIG. 27 is a front view illustrating an unlocking state of the locking mechanism shown in FIG. 24 and FIG. 28 is a cross-sectional view taken along line XXVIII-XXVIII of FIG. 27.

Referring to FIG. 22 to FIG. 26, the control panel 215 may be provided with a manipulation button insertion groove 215a. The manipulation button insertion groove 215a may be formed in a circular shape on a side surface of the control panel 215 in the lateral direction.

The manipulation member 120 may be inserted into the manipulation button insertion groove 215a to be movable in the control panel 215 in the lateral direction. The manipulation button 123 provided at the manipulation member 120 may pass through the manipulation button insertion groove 215a in the lateral direction to connect with the first connection protrusion 315.

In addition, the manipulation button 123 may be disposed at one side of the door button 230. That is, when the user presses the manipulation button 123, which is disposed at one side of the control panel 215 to be placed near the door button 230, in the lateral direction, the locking mechanism 300 may be changed to an unlocking state.

Since the structure and operation of the manipulation member 120 are the same as or similar to those of the manipulation member according to the embodiment described above, detailed description of the manipulation member 120 will be omitted.

The posture of the locking rod 310 may be changed by cooperation between the manipulation button 123 and the first connection protrusion 315. When pressed by user manipulation, the manipulation button 123 may move towards the other side in the lateral direction and the first connection protrusion 315 may move in the rotational direction of the rotational shaft 311 in conjunction with the lateral movement of the manipulation button 123.

According to this embodiment, the manipulation button 123 may connect with the first connection protrusion 315 so as to adjoin therewith in the lateral direction. Specifically, connection between the manipulation button 123 and the first connection protrusion 315 may be achieved upon contact between one end of the fitting shaft 123b of the manipulation button 123 and the first connection protrusion 315.

As such, when the manipulation button 123 connected with the first connection protrusion 315 is pressed by user manipulation, the manipulation button 123 may move towards the other side in the lateral direction.

With the manipulation button 123 adjoining the first connection protrusion 315 in the lateral direction, the manipulation button 123 may press the first connection protrusion 315 in the rotational direction of the rotational shaft 311 while moving in the lateral direction. As a result, the rotational shaft 311 may be rotated and the latch protrusion 312, 313, 314 may be moved to the locking position in conjunction with the rotation of the rotational shaft 311 (see FIG. 27).

Referring to FIG. 24 to FIG. 28, the locking rod 310 may include the rotational shaft 311 connected to the first connection protrusion 315 and the latch protrusions 312, 313, 314 connected to the rotational shaft 311.

The rotational shaft 311 is capable of rotating about the forward-backward axis. The rotational shaft 311 may be rotated by the first connection protrusion 315 moved by the manipulation button 123.

By way of example, the rotational shaft 311 may have a ring shape. The rotational shaft 311 may be rotatably coupled to the control panel 215, more specifically to the rear support plane 219.

By way of example, the rear support plane 219 may be provided with a support shaft 219b. The support shaft 219b may protrude forward from the rear support plane 219. Preferably, the support shaft 219b has a cylindrical shape extending in the front-rear direction.

The rotational shaft 311 may be rotatably fitted to an outer peripheral surface of the support shaft 219b to be rotatably disposed between the pressing plane 231 of the door button 230 and the rear support plane 219.

The first connection protrusion 315 connecting with the rotational shaft 311 may protrude from the rotational shaft 311 in the circumferential direction, towards the manipulation button 123.

For example, the rotational shaft 311 and the manipulation button 123 may be spaced apart from each other in the lateral direction and the manipulation button 123 may be disposed at one lateral side of the locking mechanism 300 to be movable in the lateral direction. The rotational shaft 311 may be disposed above the manipulation button 123. The first connection protrusion 315 may protrude from the rotational shaft 311 to extend towards the manipulation button 123, that is, in a direction between the lateral direction and the downward direction.

The latch protrusions 312, 313, 314 may be connected to the rotational shaft 311 to move in conjunction with rotation of the rotational shaft 311. In this embodiment, the latch protrusions 312, 313, 314 protrude from the rotational shaft 311 in the circumferential direction.

The locking mechanism 300 may include a first latch protrusion 312. The first latch protrusion 312 may protrude from the rotational shaft 311 in the circumferential direction of the rotational shaft 311, which is different from a direction of the first connection protrusion 315. That is, the first latch protrusion 312 and the first connection protrusion 315 may protrude from the rotational shaft 311 in the circumferential direction thereof to be directed in different directions, respectively.

The first latch protrusion 312 may be connected to the rotational shaft 311 to move in conjunction with rotation of the rotational shaft 311. The first latch protrusion 312 may be moved towards a first locking position and a first unlocking position in conjunction with rotation of the rotational shaft 311.

When the locking rod 310 has a locking posture, the first latch protrusion 312 may restrict movement of the door button 230 at the first locking position. In addition, when the locking rod 310 has an unlocking posture, the first latch protrusion 312 may allow movement of the door button 230 at the first unlocking position.

In this embodiment, a position in which the first latch protrusion 312 overlaps with a first backward protrusion 230a in the front-rear direction is known as the first locking position. Accordingly, when the first latch protrusion 312 is placed at the first locking position, the first latch protrusion 312 may be placed behind the first backward protrusion 230a on a movement path of the first backward protrusion 230a.

As such, when the first latch protrusion 312 is placed at the first locking position, the first latch protrusion 312 may restrict movement of the door button 230 behind the first backward protrusion 230a through interference with the first backward protrusion 230a.

Further, in this embodiment, a position in which the first latch protrusion 312 deviates upwards from the first locking position is known as the first unlocking position. Accordingly, when the first latch protrusion 312 is placed at the first unlocking position, the first latch protrusion 312 may deviate from the movement path of the first backward protrusion 230a.

By way of example, the first backward protrusion 230a may be placed at a location biased to the other side from the center of the door button 230 in the lateral direction and biased to a lower side from the center of the door button 230 in the up-down direction. That is, the first backward protrusion 230a may be placed at a location near a lower end of one lateral side of the door button 230.

The first latch protrusion 312 may protrude from the rotational shaft 311 to extend towards the first backward protrusion 230a, that is, in a direction between the lateral direction and the downward direction. Further, the first latch protrusion 312 may be provided with a beveled protrusion 312a slantedly extending from one end of the first latch protrusion 312.

In this embodiment, the beveled protrusion 312a slantedly extends upward from the end of the first latch protrusion 312. When the first latch protrusion 312 is placed at the first locking position, the beveled protrusion 314a directly contacts the first backward protrusion 230a.

By way of example, the first backward protrusion 230a may protrude from the pressing plane 231 in a parallelepiped shape. The first backward protrusion 230a may be formed in a parallelepiped shape having upper and lower surfaces parallel to the ground or the floor surface. In addition, the beveled protrusion 312a may be formed in a shape extending in a direction parallel to the upper and lower surfaces of the first backward protrusion 230a.

With the above structures of the first backward protrusion 230a and the beveled protrusion 312a, a contact area between the first backward protrusion 230a and the first latch protrusion 312 may be effectively enlarged. As a result, when the locking mechanism 300 maintains the locking posture of the door button 230, the first latch protrusion 312 may restrict movement of the door button 230 while stably supporting the first backward protrusion 230a.

The locking rod 310 may further include a second latch protrusion 313. The second latch protrusion 313 may protrude from the rotational shaft 311 in the circumferential direction of the rotational shaft 311, which is different from directions of the first connection protrusion 315 and the first latch protrusion 312. That is, the first connection protrusion 315, the first latch protrusion 312 and the second latch protrusion 313 may protrude from the rotational shaft 311 in the circumferential direction thereof to be directed in different directions, respectively.

The second latch protrusion 313 may be connected to the rotational shaft 311 to move in conjunction with rotation of the rotational shaft 311. The second latch protrusion 313 may be moved to a second locking position and a second unlocking position in conjunction with rotation of the rotational shaft 311.

When the locking rod 310 has a locking posture, the second latch protrusion 313 may restrict movement of the door button 230 at the second locking position. In addition, when the locking rod 310 has an unlocking posture, the second latch protrusion 313 may allow movement of the door button 230 at the second unlocking position.

In this embodiment, a position in which the second latch protrusion 313 overlaps with a second backward protrusion 230b in the front-rear direction is known as the second locking position. Accordingly, when the second latch protrusion 313 is placed at the second locking position, the second latch protrusion 313 may be placed behind the second backward protrusion 230b on a movement path of the second backward protrusion 230b.

As such, when the second latch protrusion 313 is placed at the second locking position, the second latch protrusion 313 may restrict movement of the door button 230 behind the second backward protrusion 230b through interference with the second backward protrusion 230b.

Further, in this embodiment, a position in which the second latch protrusion 313 deviates upwards (or towards one lateral side) from the second locking position is known as the second unlocking position. Accordingly, when the second latch protrusion 313 is placed at the second unlocking position, the second latch protrusion 313 may deviate from the movement path of the second backward protrusion 230b.

The first backward protrusion 230a and the second backward protrusion 230b may be spaced apart from each other in the lateral direction. In addition, the first backward protrusion 230a and the second backward protrusion 230b may be spaced apart from each other in the up-down direction. In this embodiment, the first backward protrusion 230a and the second backward protrusion 230b are spaced apart from each other in the lateral direction and in the up-down direction.

For example, the first backward protrusion 230a may be placed at a location near a lower end of one lateral side of the door button 230 and the second backward protrusion 230b may be placed at a location near an upper center of the door button 230 or an upper end of the other lateral side thereof.

Accordingly, the locking rod 310 may restrict movement of the door button 230 while supporting two backward protrusions 230a, 230b at two locations spaced apart from each other in the lateral direction and in the up-down direction. That is, the locking rod 310 may maintain a locked state of the door button 230 while stably supporting the door button 230 at multiple locations.

The locking rod 310 may further include a third latch protrusion 314. The third latch protrusion 314 may protrude from the rotational shaft 311 in a different direction from the protruding directions of the first connection protrusion 315, the first latch protrusion 312 and the second latch protrusion 313. That is, the first connection protrusion 315, the first latch protrusion 312, the second latch protrusion 313 and the third latch protrusion 314 may protrude from the rotational shaft 311 in different directions, respectively.

By way of example, the third latch protrusion 314 may protrude from the first connection protrusion 315. That is, the third latch protrusion 314 may be connected to the rotational shaft 311 via the first connection protrusion 315, which connects the rotational shaft 311 to the third latch protrusion 314, instead of being directly connected to the rotational shaft 311.

The third latch protrusion 314 may protrude from the first connection protrusion 315 in a direction from the protruding direction of the first connection protrusion 315. For example, the first connection protrusion 315 may protrude from the rotational shaft 311 in the circumferential direction thereof and the third latch protrusion 314 may protrude from the rotational shaft 311 in the rotational direction thereof. The third latch protrusion 314 may be moved to a third locking position and a third unlocking position in conjunction with rotation of the rotational shaft 311.

When the locking rod 310 has a locking posture, the third latch protrusion 314 may restrict movement of the door button 230 at the third locking position. In addition, when the locking rod 310 has an unlocking posture, the third latch protrusion 314 may allow movement of the door button 230 at the third unlocking position.

In this embodiment, a position in which the third latch protrusion 314 overlaps with a third backward protrusion 230c in the front-rear direction is known as the third locking position. Accordingly, when the third latch protrusion 314 is placed at the third locking position, the third latch protrusion 314 may be placed behind the third backward protrusion 230c on a movement path of the third backward protrusion 230c.

As such, when the third latch protrusion 314 is placed at the third locking position, the third latch protrusion 314 may restrict movement of the door button 230 behind the third backward protrusion 230c through interference with the third backward protrusion 230c.

Further, in this embodiment, a position in which the third latch protrusion 314 deviates upwards (or towards the other lateral side) from the third locking position is known as the third unlocking position. Accordingly, when the third latch protrusion 314 is placed at the third unlocking position, the third latch protrusion 314 may deviate from the movement path of the third backward protrusion 230c.

At least one of the first backward protrusion 230a and the second backward protrusion 230b may be spaced apart from the third backward protrusion 230c in the up-down direction. In addition, at least one of the first backward protrusion 230a and the second backward protrusion 230b may be spaced apart from the third backward protrusion 230c in the lateral direction. In this embodiment, the first backward protrusion 230a, the second backward protrusion 230b and the third backward protrusion 230c are spaced from one another in the lateral direction, and the second backward protrusion 230b and the third backward protrusion 230c are spaced from one another in the up-down direction.

For example, the first backward protrusion 230a may be placed at a location near a lower end of one lateral side of the door button 230 and the second backward protrusion 230b may be placed at a location near an upper center of the door button 230 or a lower end of the other lateral side thereof.

Accordingly, the locking rod 310 may restrict movement of the door button 230 while supporting three backward protrusions 230a, 230b, 230c at three locations spaced apart from one another in the lateral direction and in the up-down direction. That is, the locking rod 310 may maintain the locked state of the door button 230 while more stably supporting the door button 230 at multiple locations.

The locking mechanism 300 may further include a third resilient member 317 which resiliently supports the locking rod 310. The third resilient member 317 may provide resilient force for returning the posture of the locking rod 310, which has been changed to the unlocking posture, to the locking posture. In this embodiment, the third resilient member 317 includes a torsion spring which has one end supported by the control panel 215 and the other end supported by the locking rod 310.

By way of example, the third resilient member 317 may be coupled at one end thereof to the rear support plane 219 and at the other end thereof to the first latch protrusion 312. With this structure, the third resilient member 317 may provide resilient force for returning the first latch protrusion 312, which has moved from the first unlocking position, to the first locking position.

The third resilient member 317 may return the locking rod 310 to the locking posture while moving the second latch protrusion 313 and the third latch protrusion 314 together by moving the first latch protrusion 312, as described above.

On the other hand, the rear support plane 219 may be provided with a stopper 219c. The stopper 219c may support the locking rod 310 such that the locking rod 310 is maintained in the locking posture. The stopper 219c protrudes forward from the rear support plane 219 to be placed on the movement path of the latch protrusions 312, 313, 314 so as to support the latch protrusions 312, 313, 314.

By way of example, the stopper 219c may be disposed near a lower side of the first latch protrusion 312 to support the first latch protrusion 312 from below. The stopper 219c may restrict downward movement of the first latch protrusion 312 while supporting the first latch protrusion 312, which tends to be moved downward by resilient force from the third resilient member 317.

The first latch protrusion 312 supported by the stopper 219c may be maintained at the first locking position, whereby the locking rod 310 may be maintained in the locking posture.

The rear support plane 219 may be further provided with a support rib 219d. The support rib 219d protrudes forward from the rear support plane 219 to support the locking rod 310 at the rear thereof.

According to this embodiment, the latch protrusions 312, 313, 314 support the door button 230 at the rear thereof to restrict movement of the door button 230. Accordingly, in order for the latch protrusions 312, 313, 314 to stably restrict movement of the door button 230, the latch protrusions 312, 313, 314 may be stably supported by the rear support plane 219.

However, if the latch protrusions 312, 313, 314 are supported by the rear support plane 219 such that the entirety of the latch protrusions 312, 313, 314 contact the rear support plane 219, excessive friction may occur between the latch protrusions 312, 313, 314 and the rear support plane 219. As a result, movement of the latch protrusions 312, 313, 314 may not be efficiently achieved and the latch protrusions 312, 313, 314 or the rear support plane 219 may be very easily worn out or damaged.

Considering this point of view, according to this embodiment, with a portion among the latch protrusions 312, 313, 314 contacting the support rib 219d, the latch protrusions 312, 313, 314 may be supported by the support rib 219d.

For example, with the first latch protrusion 312, more specifically the beveled protrusion 312a contacting the support rib 219d, support of the latch protrusions 312, 313, 314 by the rear support plane 219 may be achieved.

The first latch protrusion 312 may be the longest member among the latch protrusions 312, 313, 314. The support rib 219d may selectively support the first latch protrusion 312, which may have the highest need for support among the latch protrusions 312, 313, 314, thereby enabling effective support with respect to the latch protrusions 312, 313, 314 while allowing reduction in contact area between the latch protrusions 312, 313, 314 and the rear support plane 219.

The support rib 219d may support one end of the first latch protrusion 312, that is, the beveled protrusion 312a, which directly contacts the first backward protrusion 230a, thereby enabling more stable support with respect to the latch protrusions 312, 313, 314 even when the latch protrusions 312, 313, 314 are pressed by the door button 230.

The support rib 219d may protrude from the rear support plane 219 so as to extend along a movement path of the beveled protrusion 312a. For example, the support rib 219d may be formed over a movement path of the first latch protrusion 312 from the first locking position to the first unlocking position. The support rib 219d may stably support the latch protrusions 312, 313, 314 at any position of the first latch protrusion 312.

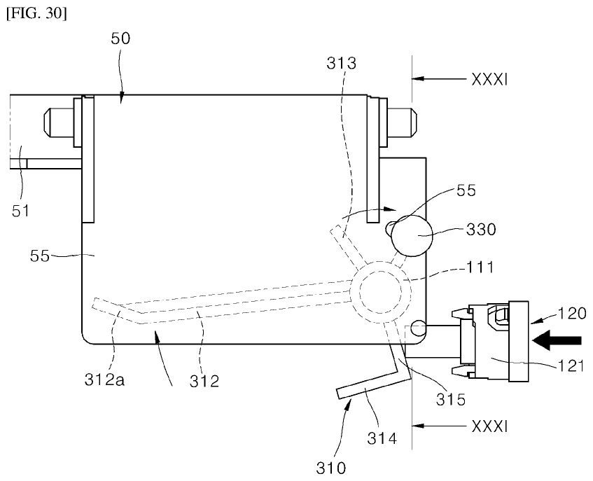

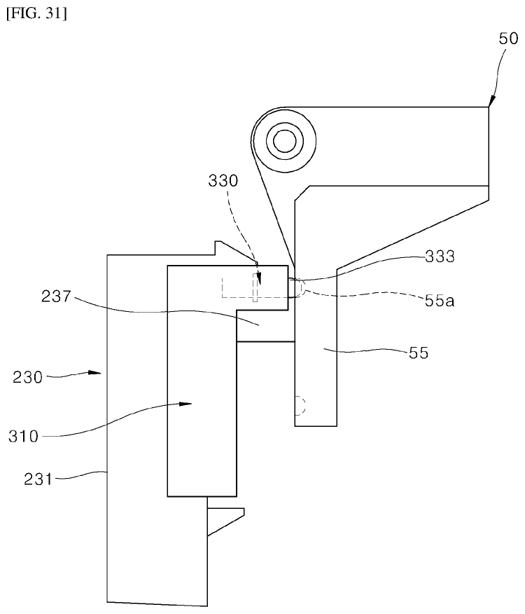

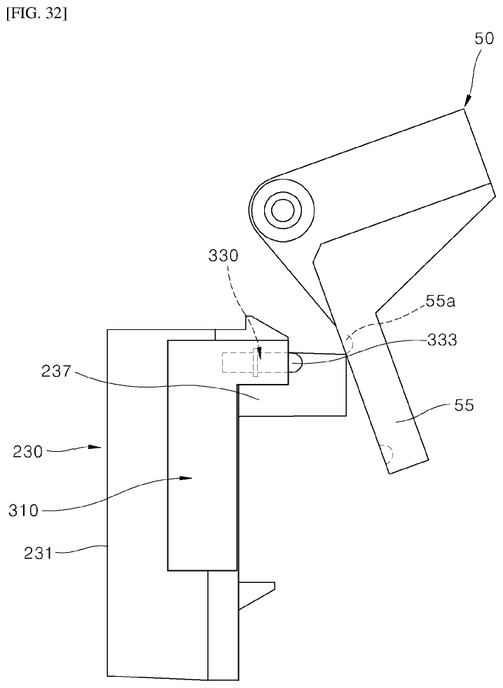

FIG. 29 is a front view illustrating the transmission panel and the locking mechanism when the locking rod is placed at a locking position and FIG. 30 is a front view illustrating the transmission panel and the locking mechanism when the locking rod is placed at an unlocking position. In addition, FIG. 31 is a cross-sectional view taken along line XXXI-XXXI of FIG. 30 and FIG. 32 is a cross-sectional view of the power transmission panel of FIG. 31 moved to an uncoupling position.

Referring to FIG. 24 and FIG. 29, the locking rod 310 may further include a locking rod-securing member 330. The locking rod-securing member 330 may be disposed to move in conjunction with movement of the latch protrusions 312, 313, 314. The locking rod-securing member 330 may be coupled to the transmission panel 55 to secure the locking rod 310 to the transmission panel 55, when the latch protrusions 312, 313, 314 are placed at the unlocking position.

In this embodiment, the locking rod-securing member 330 protrudes from the rotational shaft 311 in the circumferential direction thereof. The locking rod-securing member 330 may serve to maintain the posture of the locking rod, which has been changed to the unlocking posture, instead of returning the posture of the locking rod 310 to the locking posture, by securing the locking rod 310 to the transmission panel 55, when the latch protrusions 312, 313, 314 is placed at the unlocking position.

By way of example, the locking rod-securing member 330 may be connected to the rotational shaft 311 via a second connection protrusion 316 protruding from the rotational shaft 311 in the circumferential direction. The locking rod-securing member 330 may be connected to one end of the second connection protrusion 316 and may protrude backward from the second connection protrusion 316.

The locking rod-securing member 330 protruding backward may connect with the power transmission member 50 through the rear support plane 219. To this end, the rear support plane 219 may be provided with a second through-hole 219e. The second through-hole 219e may be formed through the rear support plane 219 in the front-rear direction.

The locking rod-securing member 330 may connect with the power transmission member 50, more specifically to the transmission panel 55, through the second through-hole 219e of the rear support plane 219.

According to this embodiment, the locking rod-securing member 330 may include a protruding boss 331, 332, a securing protrusion 333, 334, and a fourth resilient member 335.

The protruding boss 331, 332 may be connected to the second connection protrusion 316. The protruding boss 331, 332 may be connected to one end of the second connection protrusion 316 to protrude backward from the second connection protrusion 316. In this embodiment, the protruding boss 331, 332 protrudes therefrom in a cylindrical shape having a hollow space therein. The protruding boss 331, 332 may support the securing protrusion 333, 334 and the fourth resilient member 335 received therein.

The securing protrusion 333, 334 may be movably coupled to the protruding boss 331, 332. The securing protrusion 333, 334 may be inserted into the protruding boss 331, 332 to be movable therein in the front-rear direction. Most of the securing protrusion 333, 334 may be received in the protruding boss 331, 332 and a rear portion of the securing protrusion 333, 334 may protrude backward from the protruding boss 331, 332 through the protruding boss 331, 332.

The securing protrusion 333, 334 may include a protrusion portion 333 and a flange portion 334. The protrusion portion 333 may be formed in a circular bar shape extending in the front-rear direction. Most of the protrusion portion 333 may be received in the protruding boss 331, 332 and a rear portion of the protrusion portion 333 may protrude backward from the protruding boss 331, 332 through the protruding boss 331, 332. A rear end of the protrusion portion 333 may have a round shape.

The flange portion 334 may protrude from the protrusion portion 333 in the circumferential direction. The flange portion 334 may be received in the protruding boss 331, 332 and may be moved together with the protrusion portion 333 in the front-rear direction.

The protruding boss 331, 332 may be divided into a front section 331 and a rear section 332. The front section 331 and the rear section 332 may be arranged in the front-rear direction and the front section 331 may have a larger inner diameter than the rear section 332.

For example, the inner diameter of the front section 331 may be set to be greater than or equal to an outer diameter of the flange portion 334. In addition, the inner diameter of the rear section 332 may be set to a size between an outer diameter of the protrusion portion 333 and the outer diameter of the flange portion 334. In addition, a step may be formed at a border between the front section 331 and the rear section 332.

The flange portion 334 may be received in the front section 331 to move therein in the front-rear direction. A portion of the protrusion portion 333 behind the flange portion 334 may move in the rear section 332 in the front-rear direction.

Accordingly, backward movement of the securing protrusion 333, 334 may be restricted to a location in which interference between the flange portion 334 and the step occurs. Such interference between the flange portion 334 and the step may provide an effect of preventing separation of the securing protrusion 333, 334 through the protruding boss 331, 332.

The locking rod-securing member 330 may further include a boss cap 337. The boss cap 337 may be coupled to the protruding boss 331, 332 while covering an open front side of the protruding boss 331, 332.

The fourth resilient member 335 may provide resilient force that forces the securing protrusions 333, 334 to move towards the transmission panel 55, that is, in the backward direction. The fourth resilient member 335 may be provided in the form of a coil spring which has a front end supported by the boss cap 337 and a rear end supported by the flange portion 334.

According to this embodiment, the securing protrusion 333, 334 may be coupled to the transmission panel 55, whereby the locking rod-securing member 330 may be coupled to the transmission panel 55.

To this end, the transmission panel 55 may be provided with a securing groove 55a and the securing protrusion 333, 334 may be inserted into the securing groove 55a to be coupled to the transmission panel 55.

The securing groove 55a may be formed on a front surface of the transmission panel 55 facing the securing protrusion 333, 334. The securing groove 55a may be concavely formed backward on the front surface of the transmission panel 55.

In this embodiment, a rear end of the securing protrusion 333, 334 has a semispherical shape. In addition, the securing groove 55a may be formed in a concave shape on the transmission panel 55 to have a semispherical shape corresponding to the shape of the rear end of the securing protrusion 333, 334.

When the locking rod 110 has the locking posture, that is, when the locking protrusions 312, 113, 114 are placed at the locking position, the securing protrusion 333, 334 may be maintained in a contact state with the transmission panel 55 outside the securing groove 55a

Here, the securing protrusion 333, 334 may contact the transmission panel 55 in a state of being withdrawn forward instead of being placed to protrude backward as much as possible. The securing protrusion 333, 334 may be maintained in a close contact state with the transmission panel 55 by the resilient force provided by the fourth resilient member 335.

Referring to FIG. 30 and FIG. 31, when the locking rod 310 has the unlocking posture, that is, when the latch protrusions 312, 313, 314 are placed at the unlocking position, the securing protrusion 333, 334 may be moved towards the securing groove 55a along with the latch protrusions 312, 313, 314. The securing protrusion 333, 334 may be inserted into the securing groove 55a to be coupled to the transmission panel 55.

The securing protrusion 333, 334 may be pushed backward and inserted into the securing groove 55a by the resilient force provided by the fourth resilient member 335. When inserted into the securing groove 55a, the securing protrusion 333, 334 may be brought into close contact with the transmission panel 55 to be coupled to the transmission panel 55. By the securing protrusion 333, 334 being coupled to the transmission panel 55, the locking rod-securing member 330 may be coupled to the transmission panel 55.

As such, when the locking rod-securing member 330 is coupled to the transmission panel 55, the latch protrusions 312, 313, 314 moved to the unlocking position may be kept at the unlocking position. As a result, even when a force forces the latch protrusions 312, 313, 314 to move from the unlocking location, the latch protrusions 312, 313, 314 do not return to the locking position so long as coupling between the locking rod-securing member 330 and the transmission panel 55 is maintained.

Coupling between the locking rod-securing member 330 and the transmission panel 55 may be maintained even when the force forces the locking protrusion 313 to move from the unlocking position. Accordingly, once the posture of the locking rod 310 is changed from the locking posture to the unlocking posture, the posture of the locking rod 310 may be maintained in the unlocking posture so long as additional manipulation of the locking mechanism 300 is not carried out.

In the state wherein the posture of the locking rod 310 is maintained in the unlocking posture as described above, pressing manipulation with respect to the door button 30 is allowed. In this state, the door button 30 may be moved to the pressed position by the pressing manipulation.

When the door button 230 is moved to the pressed position, the transmission panel 55 may be moved backward while being pushed by the pushing protrusion 237, as shown in FIG. 32. When the transmission panel 55 moves backward, engagement between the latch mechanism and the main body is released simultaneously with the coupling between the locking rod-securing member 330 and the transmission panel 55.

As a result, the door may be opened and the locking protrusion 113 returns from the unlocking position to the locking position, whereby the posture of the locking rod 110 may be returned from the unlocking posture to the locking posture.

Hereinafter, operation and effects of the cooking appliance according to this embodiment will be described with reference to FIG. 22 to FIG. 32.

Referring to FIG. 22 to FIG. 26, while the door 20 (see FIG. 1) closes the cooking chamber 14 (see FIG. 2), the door 20 may be secured to the main body 10 by the latch mechanism 40 (see FIG. 2). In addition, the door button 230 may be secured by the locking mechanism 300 so as not to be moved to the pressed position by pressing manipulation.

In other words, while the door 20 closes the cooking chamber 14, the door 20 may be secured to the main body 10 by the latch mechanism 40 and the door button 230 for opening the door 20 may be locked by the locking mechanism 300.

That is, in the cooking appliance according to this embodiment, opening of the door 20 may be dually restricted by the latch mechanism 40 and the locking mechanism 300.

While opening of the door 20 is dually restricted by the latch mechanism 40 and the locking mechanism 300, at first, it is necessary to release the locked state of the door button 230 by the locking mechanism 300.

That is, in order to allow the door 20 to open the cooking chamber 14, the posture of the locking mechanism 300 placed behind the door button 230 and restricting movement of the door button 230 should be changed from the locking posture to the unlocking posture, as shown in FIG. 28.

To this end, as shown in FIG. 27 and FIG. 28, a user may press the manipulation button 123 on the side surface of the control panel 215 to move the manipulation button 123 in the lateral direction. Accordingly, the connection protrusion 315 connected to the manipulation button 123 may rotate the rotational shaft 311 while moving in the rotational direction of the rotational shaft 311.

As a result, the latch protrusions 312, 313, 314 are moved from the locking position to the unlocking position in conjunction with the rotation of the rotational shaft 311, whereby the latch protrusions 312, 313, 314 are released from a movement path of a backward protrusion 230a, 230b, 230c.

When the posture of the locking rod 310 is changed to the unlocking posture in this way, an obstacle placed behind the door button 230 and restricting movement of the door button 230 is removed from the movement path of the door button 230. As a result, the door button 230 may move towards the pressed position through pressing manipulation with respect to the door button 230.

When the posture of the locking rod 310 is changed to the unlocking posture as described above, the securing protrusion 333, 334 is inserted into the securing groove 55a to be coupled to the transmission panel 55, as shown in FIG. 30 and FIG. 31, whereby the locking rod-securing member 330 may be coupled to the transmission panel 55.

As such, the locking rod-securing member 330 coupled to the transmission panel 55 may maintain the posture of the locking rod 110 in the unlocking posture. Accordingly, once the user presses the manipulation member 120 to change the posture of the locking rod 110 to the unlocking posture, the unlocking posture of the locking rod 110 may be maintained even when the user does not continue to press the manipulation member 120.

That is, since the user can open the door by pressing the door button 30 again with the hand that has pressed the manipulation button 123, it is possible to open the door easily and conveniently with only one hand instead of using both hands together.

When the door is opened through pressing manipulation with respect to the door button 230, engagement between the latch mechanism and the main body is released simultaneously with the coupling between the locking rod-securing member 230 and the transmission panel 55.

Thereafter, when the force pressing the door button 230 is released, the door button 230 moves forward and returns to the original position while the latch protrusions 312, 313, 314 return from the unlocking position to the locking position.

As such, opening of the door may be achieved together with posture returning of the locking rod 310 by pressing manipulation with respect to the door button 230, whereby locking of the door button 230 may be automatically achieved even without additional manipulation, when the door 20 is closed again

When the locking rod 110 automatically returns to a securing position such that the door 20 is rotated backward again to close the cooking chamber 14, the door 20 may be locked again by the locking mechanism 300 even without separate manipulation with respect to the locking mechanism 300.

That is, in the cooking appliance according to this embodiment, the door button 230 may be released from the locked state by the locking mechanism 300 through the pressing manipulation with respect to the manipulation button 123 and the door button 230 may be locked again by the locking mechanism 300 even without separate manipulation.

The door button 230 may be released from the locked state by the locking mechanism 300 by pulling the locking mechanism 300 in the lateral direction and the door button 230 may be locked again by the locking mechanism 300 even without separate manipulation after opening or closing of the door 20 (see FIG. 2).

Accordingly, the cooking appliance according to this embodiment allows for easy and convenient restriction of the door 20 to prevent unintentional opening of the cooking chamber 14 (see FIG. 2) while allowing automatic and safe locking of the door button 30 even without separate manipulation.

For the cooking appliance according to this embodiment as described above, restriction of the door button 230 is first released in order to allow manipulation for opening the door 20, thereby effectively preventing unintentional opening of the cooking chamber 14 during operation of the cooking appliance.

In addition, the cooking appliance according to this embodiment allows the locking rod 310 to automatically return to the original posture, in which the locking rod 310 locks the door button 230, even without separate manipulation, thereby improving both stability of the cooking appliance and convenience in manipulation thereof.

Further, the cooking appliance according to this embodiment suppresses frequent unnecessary opening/closing of the door 20, thereby effectively suppressing unstable opening/closing operation of the door 20 due to the latch mechanism 40 being worn out prematurely.

[Third Embodiment of Locking Mechanism]

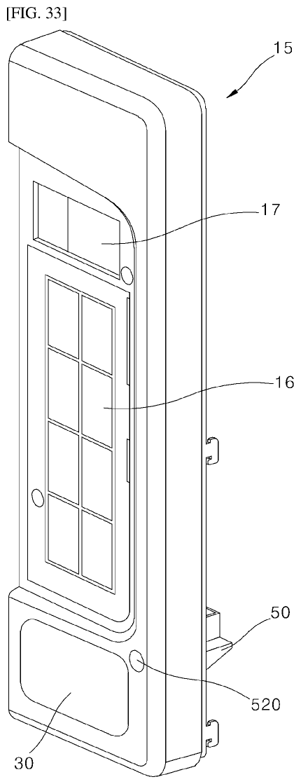

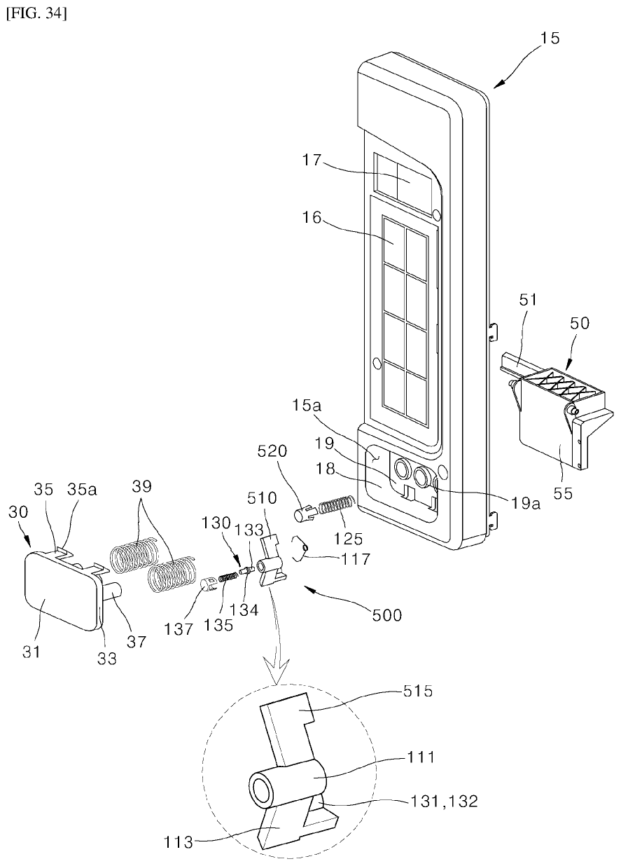

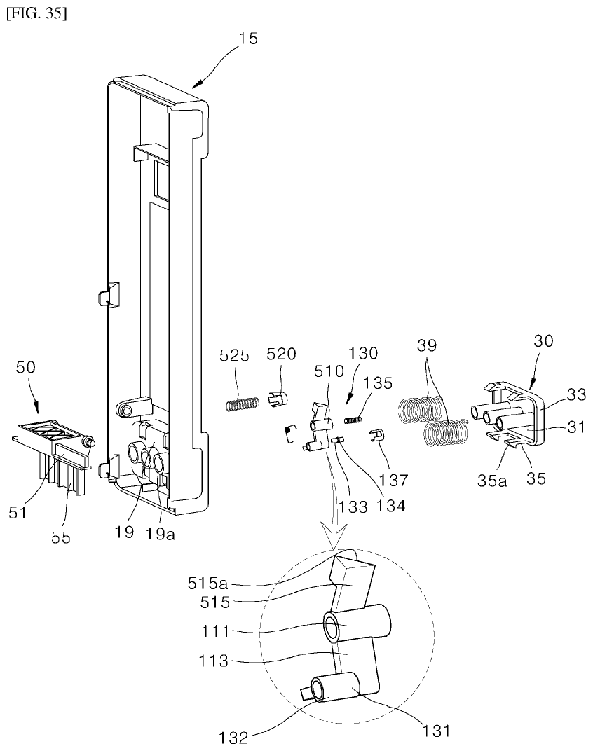

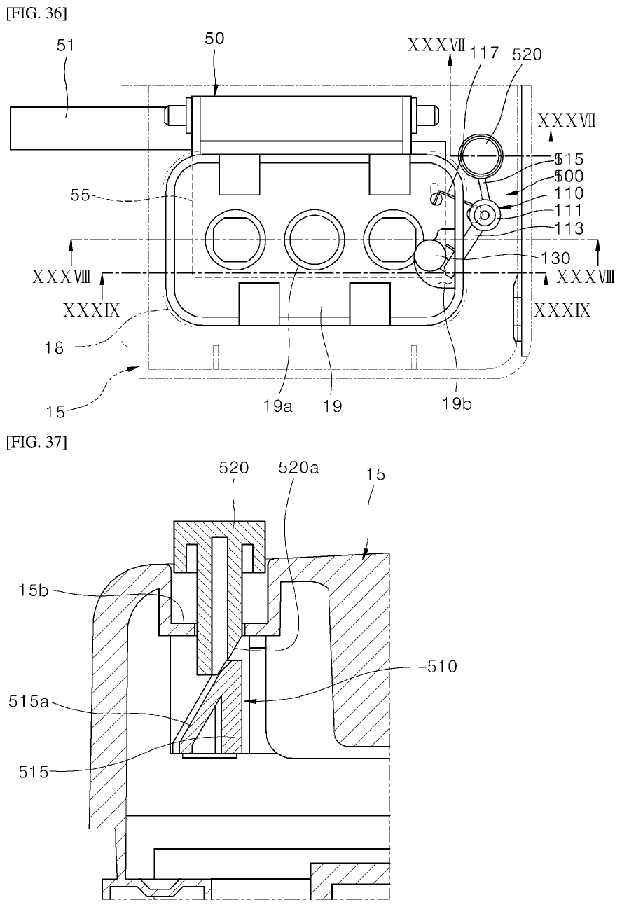

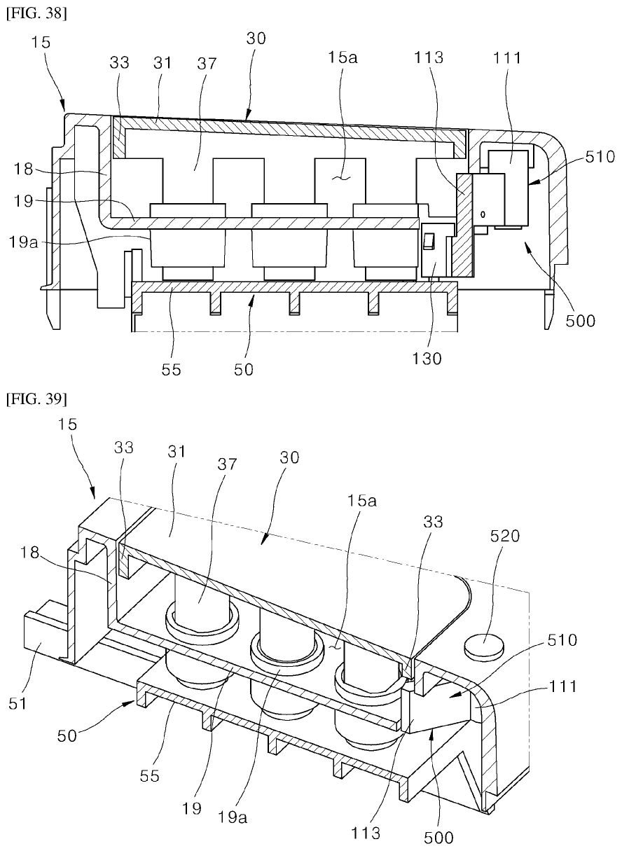

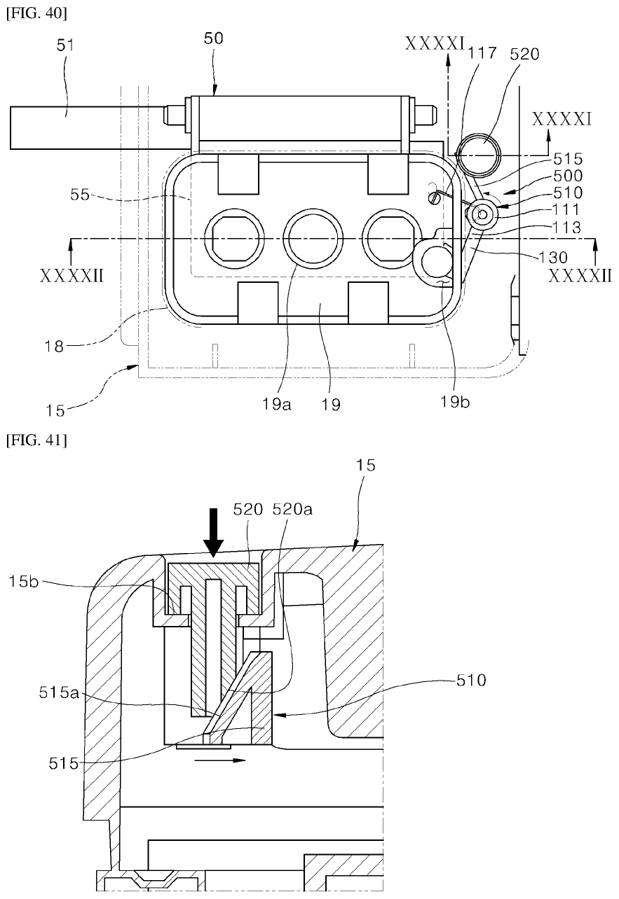

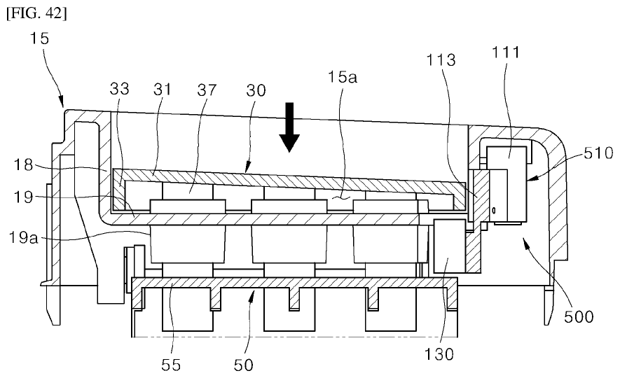

FIG. 33 is a perspective view of a control panel separated from a cooking appliance according to a third embodiment of the present disclosure, FIG. 34 is an exploded front perspective view of the control panel and a locking mechanism shown in FIG. 33, and FIG. 35 is an exploded rear perspective view of the control panel and the locking mechanism shown in FIG. 33. In addition, FIG. 36 is a partially enlarged front view of a door button shown in FIG. 33 and FIG. 37 is a cross-sectional view taken along line XXXVII-XXXVII of FIG. 36. Further, FIG. 38 is a cross-sectional view taken along line XXXVIII-XXXVIII of FIG. 36, FIG. 39 is a cross-sectional view taken along line XXXIX-XXXIX of FIG. 36, FIG. 40 is a front view illustrating an unlocking state of a locking mechanism shown in FIG. 36, FIG. 41 is a cross-sectional view taken along line XXXXI-XXXXI of FIG. 40, and FIG. 42 is a cross-sectional view taken along line XXXXII-XXXXII of FIG. 40.

A main difference between the locking mechanism of the cooking appliance according to the third embodiment of the present disclosure and the locking mechanisms of the cooking appliances according to the above embodiments is the manipulation button.

Hereinafter, the cooking appliance according to the third embodiment will be described with reference to FIG. 33 to FIG. 42.

Referring to FIG. 33 to FIG. 39, the locking mechanism 500 according to the third embodiment may include a manipulation button 520 capable of being pressed by user manipulation.

In this embodiment, the manipulation button 520 is disposed on the front surface of the control panel 15. Accordingly, the manipulation button 520 may be disposed on the control panel 15 so as to be movable in the front-rear direction.

When pressed by user manipulation, the manipulation button 520 may move backward. In addition, when pressed by user manipulation, the manipulation button 520 may change the posture of a locking rod 510 from a locking posture to an unlocking posture.

The manipulation button 520 may be inserted into a manipulation button insertion groove 15b to be movable in the control panel 15 in the front-rear direction. The manipulation button 520 may connect with a pressing protrusion 515 through the manipulation button insertion groove 15b in the front-rear direction.

The manipulation button insertion groove 15b may be provided with a second resilient member 525 that resiliently supports the manipulation button 520. The second resilient member 525 may provide resilient force for returning the manipulation button 520, which has been moved backward by the pressing manipulation, to the original position. The second resilient member 525 may be provided in the form of a coil spring which has a rear end supported by the manipulation button insertion groove 15b and a front end supported by the manipulation button 520.

The manipulation button 520 may be disposed at one side of the door button 30. That is, when a user presses the manipulation button 520, which is disposed on the front surface of the control panel 15 to be placed near the door button 30, in the backward direction, the locking mechanism 500 may be changed to an unlocking state.

The posture of the locking rod 510 may be changed by cooperation between the manipulation button 520 and the pressing protrusion 515. When pressed by user manipulation, the manipulation button 520 may move backward and the pressing protrusion 515 may move in the rotational direction of the rotational shaft 111 in conjunction with movement of the manipulation button 520 in the front-rear direction.

According to this embodiment, the manipulation button 520 may connect with the pressing protrusion 515 so as to adjoin therewith in the front-rear direction. In addition, at least one of the manipulation button 520 and the pressing protrusion 515 may be formed with beveled planes 515a, 520a.

Accordingly, a rear end of the manipulation button 520 may slide along the beveled planes 515a which are formed on a front end of the pressing protrusion 515, to move backward such that the pressing protrusion 515 may be moved in the rotational direction of the rotational shaft 111.

Alternatively, the front end of the pressing protrusion 515 may slide along the beveled planes 520a formed on the rear end of the manipulation button 520 by the manipulation button 520 moving backward. Accordingly, the pressing protrusion 515 may be moved in the rotational direction of the rotational shaft 111 while being pressed by the manipulation button 520.

In this embodiment, the pressing protrusion 515 and the manipulation button 520 are formed with the beveled planes 515a, 520a, respectively.

For example, the rear end of the manipulation button 520 facing the pressing protrusion 515 may be formed with a first beveled plane 520a. In addition, the front end of the pressing protrusion 515 facing the manipulation button 520 may be formed with a second beveled plane 515a. As a result, the manipulation button 520 and the pressing protrusion 515 may connect with each other such that the first beveled plane 520a adjoins the second beveled plane 515a in the front-rear direction.

The first beveled plane 515a may form a plane gradually beveled in the circumferential direction of the rotational shaft 111. The second beveled plane 520a may form a plane parallel to the first beveled plane 515a.

When pressed by user manipulation, the manipulation button 520 may move backward, as shown in FIG. 41. With the first beveled plane 515a adjoining the second beveled plane 520a, the manipulation button 520 moving backward may press the pressing protrusion 515 in the rotational direction of the rotational shaft 111.

Accordingly, as shown in FIG. 40 to FIG. 42, the rotational shaft 111 may be rotated and the latch protrusion 113 may be moved to the locking position in conjunction with rotation of the rotational shaft 111.

[Fourth Embodiment of Locking Mechanism]

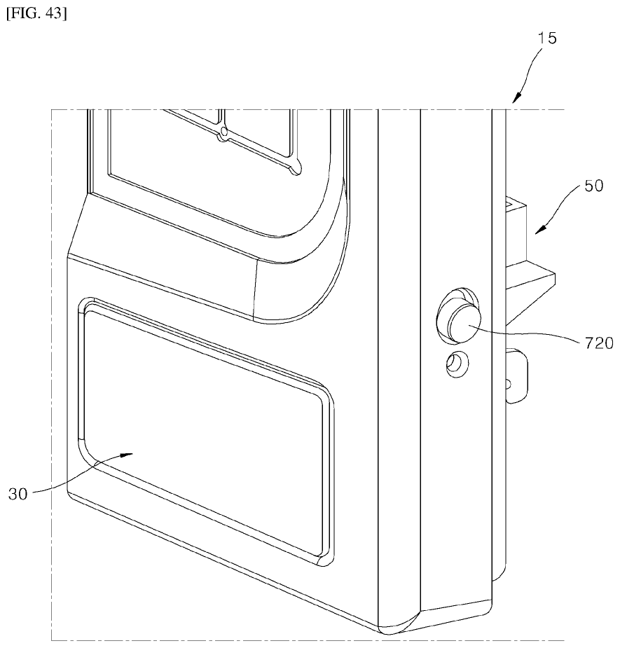

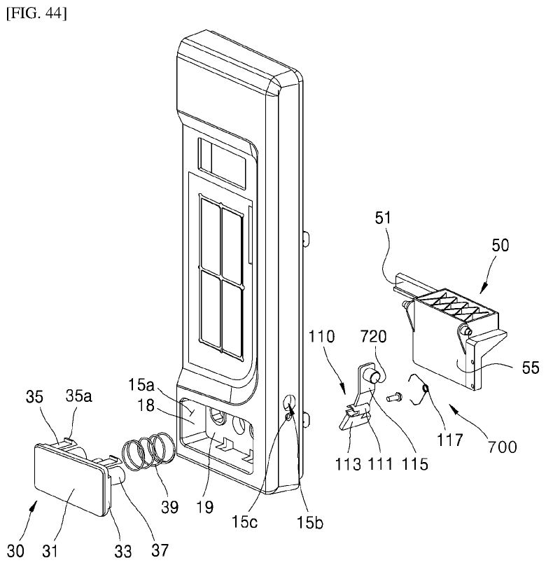

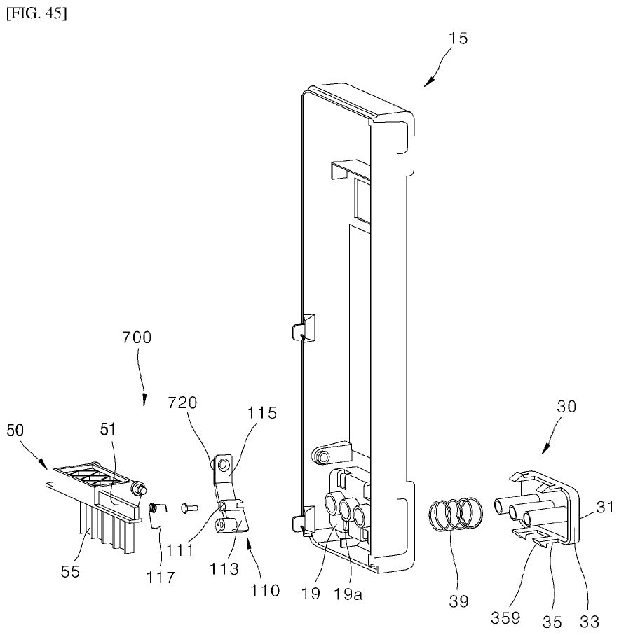

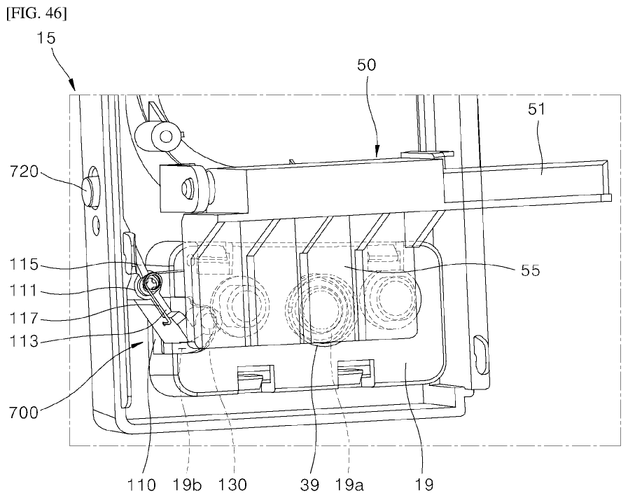

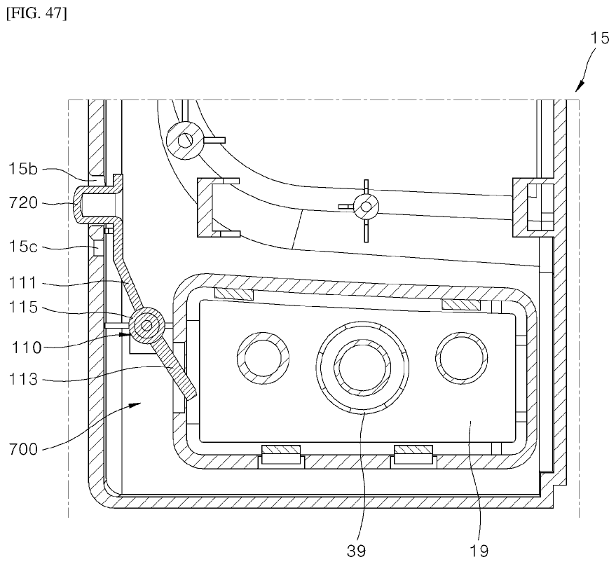

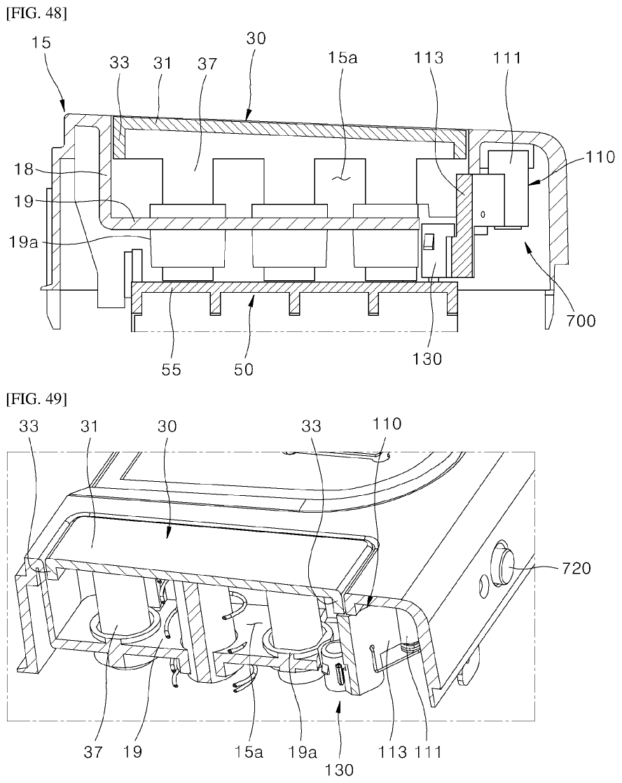

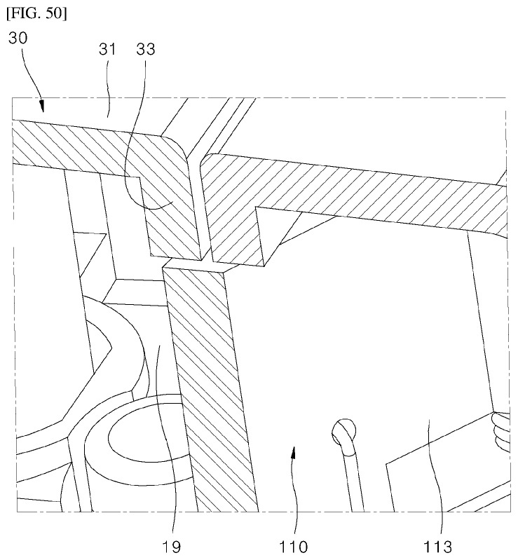

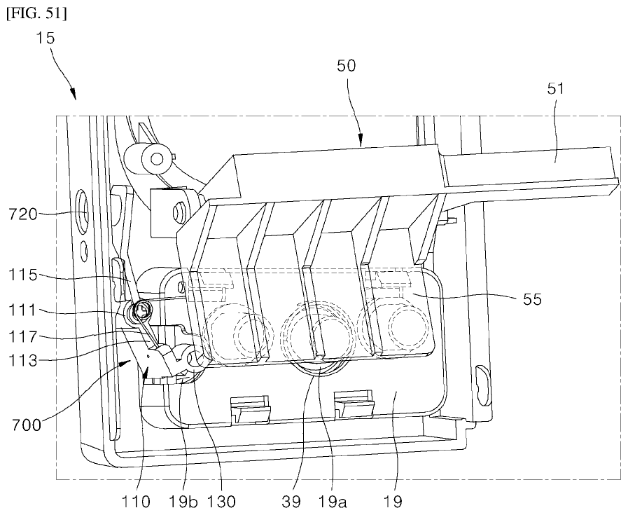

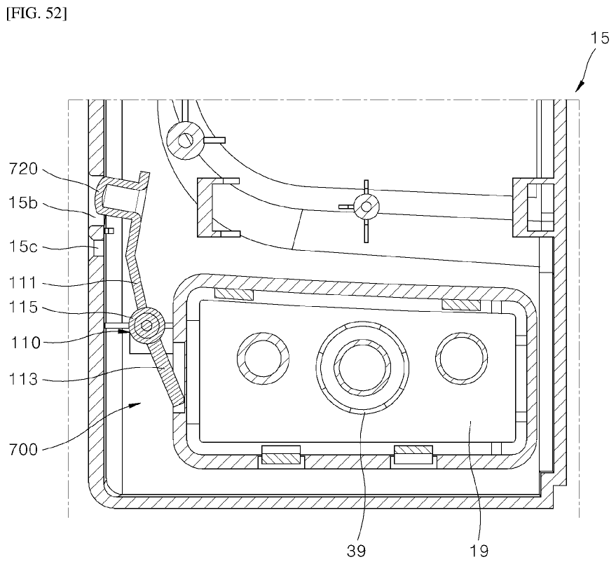

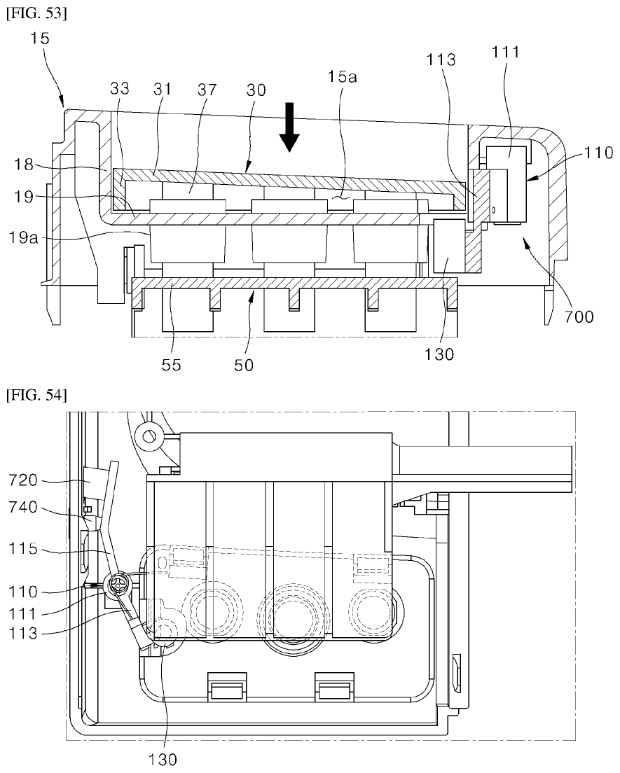

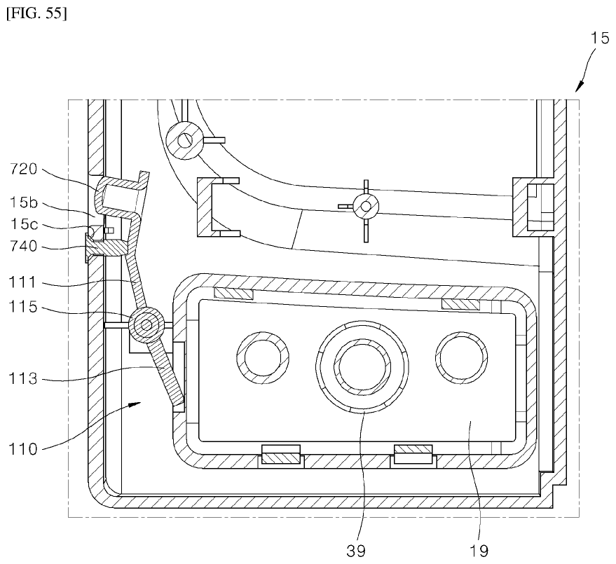

FIG. 43 is a perspective view of a control panel separated from a cooking appliance according to a fourth embodiment of the present disclosure, FIG. 44 is an exploded front perspective view of the control panel and a locking mechanism shown in FIG. 43, and FIG. 45 is an exploded rear perspective view of the control panel and the locking mechanism shown in FIG. 43. In addition, FIG. 46 is an enlarged rear perspective view of a door button shown in FIG. 43 and FIG. 47 is a cross-sectional view of a manipulation button shown in FIG. 46. Further, FIG. 48 is a cross-sectional view of a locking mechanism according to the fourth embodiment of the present disclosure and FIG. 49 is a sectional perspective view of the locking mechanism according to the fourth embodiment of the present disclosure. Further, FIG. 50 is a partially enlarged view of the door button and the locking mechanism shown in FIG. 49 and FIG. 51 is a rear perspective view illustrating an unlocking state of the locking mechanism shown in FIG. 46. Further, FIG. 52 is a rear view illustrating the unlocking state of the locking mechanism shown in FIG. 46 and FIG. 53 is a cross-sectional view of the locking mechanism shown in FIG. 50. Further, FIG. 54 is a rear view illustrating a function-release state of the locking mechanism shown in FIG. 52 and FIG. 55 is a cross-sectional view illustrating the function-release state of the locking mechanism shown in FIG. 54

A main difference between the locking mechanism of the cooking appliance according to the fourth embodiment of the present disclosure and the locking mechanisms of the cooking appliances according to the above embodiments is the manipulation button.

Hereinafter, the cooking appliance according to the fourth embodiment of the present disclosure will be described with reference to FIG. 43 to FIG. 53.

Referring to FIG. 43 to FIG. 50, the manipulation button 720 is capable of being pressed by user manipulation. When pressed by user manipulation, the manipulation button 720 may change the posture of the locking rod 110 from the locking posture to the unlocking posture.

In this embodiment, the manipulation button 720 is disposed on a side surface of the control panel 15. Accordingly, the manipulation button 720 may be disposed on the control panel 15 to be movable in the left-right direction.

When pressed by user manipulation, the manipulation button 720 may move in the lateral direction. For example, the manipulation button 720 disposed on a left side surface of the control panel 15 may move to the right when pressed by user manipulation. The manipulation button 720 may be inserted into a manipulation button-insertion hole 15b to be disposed on the side surface of the control panel 15.

The manipulation button 720 may be connected to the locking rod 110. More specifically, the manipulation button 720 may be connected to the first connection protrusion 115.

The manipulation button 720 may protrude from the first connection protrusion 115 in the lateral direction. The manipulation button 720 may protrude from one end of the first connection protrusion 115, that is, from the farthest portion of the first connection protrusion 115 from the rotational shaft 111 in the lateral direction.

By way of example, the manipulation button 720 may be integrally formed with the locking rod 110. In this structure, the rotational shaft 111, the latch protrusion 113, the first connection protrusion 115 and the manipulation button 720 may be integrally formed with one another as a single member.

As such, since the manipulation button 720 is integrally formed with the locking rod 110, the number of components constituting a locking mechanism 700 may be reduced. Accordingly, the cooking appliance according to the fourth embodiment may facilitate management and assembly of components to achieve reduction in time and cost for assembly.

As such, since the manipulation button 720 is integrally formed with the locking rod 110, force applied through the manipulation button 720 may be efficiently transferred to the locking rod 110, thereby improving accuracy of manipulation through the manipulation button 720.

In addition, the manipulation button 720 may be disposed at one side of the door button 30. That is, when a user presses the manipulation button 720 disposed at one side of the control panel 15 that is close to the door button 30, the locking mechanism 700 may be changed to an unlocking state.

The posture of the locking rod 110 may be changed by cooperation between the manipulation button 720 and the first connection protrusion 115. When pressed by user manipulation, the manipulation member 720 may move in the lateral direction and the first connection protrusion 115 may move in the rotational direction of the rotational shaft 111 in conjunction with lateral movement of the manipulation member 720.

As shown in FIG. 51 to FIG. 53, the user can move the manipulation button 720 in the lateral direction by pressing the manipulation button 720. As a result, the first connection protrusion 115 connected to the manipulation button 720 may rotate the rotational shaft 111 while moving in the rotational direction thereof.

As a result, the latch protrusion 113 is moved from the locking position to the unlocking position in conjunction with the rotational shaft 111, whereby the locking rod 110 may deviate from the movement path of the door button 30.

When the posture of the locking rod 110 is changed to the unlocking posture in this way, an obstacle placed behind the door button 30 and restricting movement of the door button 30 is removed from the movement path of the door button 30. As a result, the door button 30 may move towards a pressed position through the pressing manipulation with respect to the door button 30

The control panel 15 may be formed on a side surface thereof with a securing member-insertion hole 15c, as shown in FIG. 54 and FIG. 55. Like the manipulation button-insertion hole 15b, the securing member-insertion hole 15c may be formed on the side surface of the control panel 15 to pass therethrough in the lateral direction.

The securing member-insertion hole 15c may be disposed near the manipulation button-insertion hole 15b. By way of example, the securing member-insertion hole 15c may be disposed below the manipulation button-insertion hole 15b. That is, the securing member-insertion hole 15c may be disposed closer to the rotational shaft 111 than the manipulation button-insertion hole 15b.

The locking mechanism may further include a securing member 740. The securing member 740 may be used to release a locking function of the door 20 using the locking mechanism 700.

By way of example, the securing member 740 may be provided in the form of a fastening member fitted into the side surface of the control panel 15. For example, the securing member 740 may be inserted into the securing member-insertion hole 15c and may be provided in the form of a screw penetrating the control panel 15.

The securing member 740 may be inserted into the securing member-insertion hole 15c to be coupled to the side surface of the control panel 15 and may enter the control panel 15 through the side surface of the control panel 15. The securing member 740 may protrude towards the first connection protrusion 115 after passing through the side surface of the control panel 15 in the lateral direction.

By way of example, the securing member 740 may be disposed between the rotational shaft 111 of the locking rod 110 and the manipulation button 720 in the up-down direction. The securing member 740 may contact the first connection protrusion 115 between the rotational shaft 111 and the manipulation button 720.

With the manipulation button 720 pressed, the securing member 740 may support the first connection protrusion 115 at one lateral side of the first connection protrusion 115 while contacting the first connection protrusion 115. That is, the securing member 740 may restrict movement of the locking rod 110 through interference with the first connection protrusion 115 so as to prevent change of the posture of the locking rod 110.

As a result, the locking rod 110 may be maintained in the unlocking posture and the locking mechanism 700 may be maintained in a function-released state in which the locking rod 110 is separated from the door 20.

That is, the locking mechanism 700 according to this embodiment may provide a dual door-securing function for automatically and stably securing the door 20 while allowing the dual door-securing function not to be performed when this function is not needed.

Accordingly, the cooking appliance according to this embodiment may provide a function of allowing the user to select whether to use the dual door-securing function according to the user's need by allowing release of the dual door-securing function in a place where the dual door-securing function is unnecessary, such as a house without children.

Although some embodiments have been described herein with reference to the accompanying drawings, it should be understood that these embodiments are provided for illustration only and are not to be construed in any way as limiting the present disclosure, and that various modifications, changes, alterations, and equivalent embodiments can be made by those skilled in the art without departing from the spirit and scope of the present disclosure.

What is claimed is:

1. A cooking appliance comprising:
a main body having a cooking chamber therein and open at a front side thereof;
a door provided to the front side of the main body to open or close the cooking chamber;
a door button capable of being pressed by user manipulation to move to a pressed position to allow the door to be opened; and
a locking mechanism selectively restricting movement of the door button,
wherein the locking mechanism comprises a locking rod allowing change of a posture of the locking mechanism to a locking posture restricting movement of the door button to the pressed position and an unlocking posture allowing movement of the door button to the pressed position; and a manipulation button capable of being pressed by the user manipulation to change the posture of the locking rod from the locking posture to the unlocking posture.

2. The cooking appliance according to claim 1, wherein:
the locking mechanism further comprises a button housing coupled to the main body, the manipulation button to move in a direction in the button housing to change the posture of the locking rod when pressed by the user manipulation; and
the posture of the manipulation button is changed to one of a posture allowing movement of the manipulation button in the direction and a posture restricting movement of the manipulation button in the direction upon rotation of the manipulation button.

3. The cooking appliance according to claim 2, wherein the manipulation button comprises:
a pressing plane capable of being pressed by the user manipulation; and
a fitting shaft protruding from the pressing plane and inserted into a hollow space of the button housing,
the fitting shaft movable in the hollow space of the button housing in the direction and to be rotatable therein, and capable of being connected with the locking rod to change the posture of the locking rod.

4. The cooking appliance according to claim 3, wherein:
the button housing includes a latch groove at one end of the button housing in the movement direction of the manipulation button, and
the manipulation button further comprises a latch protrusion protruding from the fitting shaft to be insertable into the latch groove,
the latch protrusion movable along with the fitting shaft in the direction to one of an insertion position in which the latch protrusion is inserted into the latch groove and a separation position in which the latch protrusion is separated from the latch groove.

5. The cooking appliance according to claim 4, wherein the fitting shaft is capable of pushing the locking rod to change the posture of the locking rod from the locking posture to the unlocking posture, and when the posture of the locking rod is changed to the unlocking posture, the latch protrusion is in the separation position.

6. The cooking appliance according to claim 4, wherein:
the locking mechanism further comprises a resilient member providing resilient force for returning the manipulation button from the pressed position to an original position;
the button housing including a latch step to block movement of the latch protrusion separated from the latch groove to move towards the insertion position; and
the latch groove and the latch step are disposed in a rotational direction of the manipulation button.

7. The cooking appliance according to claim 6, wherein the button housing further comprises a rotation-suppressing protrusion disposed between the latch groove and the latch step and protruding from the button housing beyond the latch step.

8. The cooking appliance according to claim 1, wherein the locking rod comprises:
a rotational shaft rotatable about an axis;
a locking protrusion to restrict movement of the door button from behind the door button at a locking position and allowing movement of the door button by being moved to an unlocking position, the locking protrusion connected to the rotational shaft to move between the locking position and the unlocking position in conjunction with a rotation of the rotational shaft; and
a connection protrusion extending from the rotational shaft to connect with the manipulation button and moved to rotate the rotational shaft in conjunction with a movement of the manipulation button.

9. The cooking appliance according to claim 8, wherein:
the connection protrusion protrudes from the rotational shaft;
the manipulation button is disposed at one side of the connection protrusion, the manipulation button movable in a lateral direction; and
the connection protrusion is moved in a rotational direction of the rotational shaft in conjunction with the lateral movement of the manipulation button.

10. The cooking appliance according to claim 1, wherein, when the locking rod has the locking posture, at least a portion of the locking rod is disposed on a movement path of the door button, and when the locking rod has the unlocking posture, the locking rod deviates from the movement path of the door button.

11. The cooking appliance according to claim 10, wherein the locking rod comprises:
a rotational shaft rotatable about an axis;
a latch protrusion to restrict movement of the door button from behind the door button at a locking position and allowing movement of the door button by being moved to an unlocking position, the latch protrusion connected to the rotational shaft to move between the locking position and the unlocking position in conjunction with a rotation of the rotational shaft; and
a pressing protrusion extending from the rotational shaft to connect with the manipulation button to rotate the rotational shaft while moving in conjunction with movement of the manipulation button, the pressing protrusion being moved in a rotational direction of the rotational shaft in conjunction with forward-backward movement of the manipulation button.

12. The cooking appliance according to claim 11, wherein:
the manipulation button is brought into contact with the pressing protrusion in a front-rear direction; and
at least one of a rear end of the manipulation button facing the pressing protrusion and a front end of the pressing protrusion facing the manipulation button is formed with a beveled plane, the rear end of the manipulation button moving the pressing protrusion in the rotational direction of the rotational shaft while sliding along the beveled plane, or the pressing protrusion being moved in the rotational direction of the rotational shaft while the front end of the pressing protrusion slides along the beveled plane.

13. The cooking appliance according to claim 1, wherein:
the door button comprises a pressing plane capable of being pressed by the user manipulation and an edge protrusion extending backward from a lateral edge of the pressing plane;
when the locking rod has the unlocking posture, the locking mechanism is placed outside the door button in a lateral direction; and
when the locking rod has the locking posture, at least a portion of the locking rod is disposed on a movement path of the edge protrusion.

14. The cooking appliance according to claim 13, further comprising:
a control panel disposed at a front side of the main body and placed at one side of the door,
wherein the control panel includes a door button-insertion hole penetrating the control panel in a front-rear direction such that the door button is inserted into the door button-insertion hole to be movable at the control panel in the front-rear direction,
the control panel comprising a front surface forming a plane parallel to the door and an inner surface extending backward from the front surface and surrounding the door button-insertion hole, and
the edge protrusion extends backward from the pressing plane while forming a plane parallel to the inner surface.

15. The cooking appliance according to claim 14, wherein:
the inner surface includes a through-hole disposed between the manipulation button and the door button-insertion hole to pass through the inner surface in the lateral direction; and
at least a portion of the locking rod protrudes to a region between the rear support plane and the edge protrusion through the through-hole at the locking position.

16. The cooking appliance according to claim 1, further comprising:
a latch mechanism provided at the door to couple to the main body; and
a power transmission panel capable of moving to a coupling position and an uncoupling position,
wherein when the latch mechanism is coupled to the main body to secure the door at a closing position, the power transmission panel at the coupling position allows coupling between the latch mechanism and the main body and when the door button is moved to the pressed position, the power transmission panel is moved to the uncoupling position in which coupling between the latch mechanism and the main body is released.

17. The cooking appliance according to claim 16, wherein the locking rod comprises:
a rotational shaft rotatable about an axis;
a latch protrusion to restrict movement of the door button from behind the door button at a locking position and allowing movement of the door button by being moved to an unlocking position, the latch protrusion connected to the rotational shaft to move between the locking position and the unlocking position in conjunction with a rotation of the rotational shaft; and
a locking rod-securing member extending from the rotational shaft, the locking rod-securing member being moved in conjunction with a movement of the latch protrusion and being coupled to the transmission panel to secure the locking rod to the transmission panel when the latch protrusion is placed at the unlocking position.

18. The cooking appliance according to claim 17, wherein:
the locking rod-securing member comprises:
a protruding boss connected to the latch protrusion;
a securing protrusion coupled to the protruding boss and movable in the front-rear direction, at least a portion of the securing protrusion protruding from the protruding boss towards the transmission panel; and
a resilient member providing resilient force forcing the securing protrusion to move towards the transmission panel; and
the securing protrusion is capable for coupling to the transmission panel to allow coupling between the locking rod-securing member and the transmission panel.

19. The cooking appliance according to claim 1, wherein the manipulation button is integrally formed with the locking rod.
